(19) United States
(12) Patent Application Publication
(10) Pub. No.: US 2008/0243721 A1
(43) Pub. Date: Oct. 2, 2008

(54) Apparatus and method for providing financial information and/or investment information

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 12/154,788

(22) Filed: May 27, 2008

Related U.S. Application Data
(63) Continuation-in-part of application No. 09/639,908, filed on Aug. 16, 2000.
(60) Provisional application No. 60/150,410, filed on Aug. 24, 1999.
(60) Provisional application No. 60/218,265, filed on Jul. 13, 2000.

(51) Int. Cl. G06Q 40/00

(52) U.S. Cl. 705/36 R

(57) ABSTRACT

An apparatus for providing financial or investment information, including a receiver which receives a request to provide a notification of a change in at least one factor and information regarding a correlation of the at least one factor with an investment vehicle or entity, a processor which automatically detects a change in at least one factor upon an occurrence of same, processes the request, and generates a message containing information regarding the change in the at least one factor along with information regarding a correlation of the at least one factor with the investment vehicle or entity, and a transmitter for transmitting the message over a communication network to a communication device associated with an individual. The apparatus automatically initiates a communication link with the communication device and the transmitter transmits the message to the communication device in real-time.

### RELATED APPLICATIONS

This application is a continuation-in-part application of U.S. patent application Ser. No. 09/639,908, filed Aug. 16, 2000. U.S. patent application Ser. No. 09/639,908, filed Aug. 16, 2000, claims the benefit of priority of U.S. Provisional Patent Application Ser. No. 60/150,410, filed Aug. 24, 1999, and entitled “APPARATUS AND METHOD FOR PROVIDING FINANCIAL INFORMATION AND/OR INVESTMENT INFORMATION”, the subject matter of which is hereby incorporated by reference herein. U.S. patent application Ser. No. 09/639,908, filed Aug. 16, 2000, also claims the benefit of priority of U.S. Provisional Patent Application Ser. No. 60/218,265, filed Jul. 13, 2000, and entitled “APPARATUS AND METHOD FOR PROVIDING FINANCIAL INFORMATION AND/OR INVESTMENT INFORMATION”, the subject matter of which is also hereby incorporated by reference herein.

### FIELD OF THE INVENTION

The present invention is directed to an apparatus and a method for providing financial information and/or investment information, and, in particular, to an apparatus and a method for providing financial information, investment information, notification of financial events, financial forecasting, and/or investor or consumer information, by utilizing financial factors, factors, factor models, financial variables, financial events, and/or related occurrences, in a network environment.

### BACKGROUND OF THE INVENTION

The U.S. financial services sector is currently worth in the neighborhood of $1.6 trillion dollars. It is no doubt that a major portion of the assets in the financial services sector includes stocks, bonds, securities, portfolios of securities, mutual funds, trusts, stock derivatives, bond derivatives, futures, forwards, options, securities, portfolios of securities, mutual funds, trusts, derivatives, currency, foreign currency, and/or portfolios, and/or other financial instruments or related instruments or products, containing any one or more of the above. As a result, great efforts have been undertaken in order to study and/or to attempt to predict the behavior of the various markets relating to any of the above stocks, bonds, securities, portfolios of securities, mutual funds, trusts, stock derivatives, bond derivatives, securities, portfolios of securities, mutual funds, trusts, derivatives, currency, foreign currency, and/or portfolios, and/or other financial instruments or related instruments or products.

Interest in financial investing has always been of great interest to many individuals. This interest in financial investing has recently been further fueled by the so-called “Baby Boomers” as they attempt to invest for their retirement as well as by young people hoping to reap the rewards in what is expected to be an appreciating or “Bull” market.

As is common in most other fields, including fields involving sciences, statistics, and/or human behavior, the financial markets have been studied and, it can be reasonably be argued that, they appear to exhibit activities, fluctuations, etc., which can be studied mathematically and/or statistically. It has also been observed that different events, occurrences, and/or elements of the financial environment, and/or factors or factor models, can effect the financial markets in one way or another. For example, the January effect has been used to describe a tendency for the stock prices to appreciate during the month of January.

Other factors, such as time of month, time of week, time of day, month of year (i.e. “the January effect”), inflation rate or changes in inflation rate, consumer price index or changes in consumer price index, and/or any other number of factors, as well as factors which are, or which may be, utilized in various technical and/or fundamental analysis of various stocks, bonds, securities, portfolios of securities, mutual funds, trusts, stock derivatives, bond derivatives, securities, portfolios of securities, mutual funds, trusts, derivatives, currency, foreign currency, and/or portfolios, and/or other financial instruments or related instruments or products, have also been studied.

Access to information, regarding the behavior of stocks, bonds, securities, portfolios of securities, mutual funds, trusts, stock derivatives, bond derivatives, securities, portfolios of securities, mutual funds, trusts, derivatives, currency, foreign currency, and/or portfolios, and/or other financial instruments or related instruments or products, and related information, has historically been restricted to only certain individuals with such information being closely held and guarded by financial analysts, financial advisors, brokers, dealers, etc. As a result, only a small portion of the investment community and the investing public has been able to take advantage of this financial information and related information.

The free flow or dissemination of financial market information would serve to improve market efficiency and market liquidity, thereby improving the operation of the financial markets and benefiting market participants.

As interest in investing in the financial markets continues to grow, so too does the need to provide and/or to disseminate financial information and related information to individual investors as well as institutional investors.

### SUMMARY OF THE INVENTION

The apparatus and method of the present invention overcomes the shortcomings of the prior art and provides an apparatus and a method for providing an apparatus and a method for providing financial information, investment information, notification of financial events, financial forecasting, and/or investor or consumer information, in a network environment. In particular, the present invention provides an apparatus and a method for providing financial information, notification of financial events, and/or financial forecasting, by utilizing financial factors, factor models, financial variables, financial events, and/or related occurrences, in a network environment.

The present invention utilizes the technologies and advances in information technology and in communication technology in order to provide the herein-described information, services, and/or products, in a network environment.

The present invention can be utilized so as to provide information regarding the behavior of any of the financial markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, and/or any derivatives, futures, forwards, options, contracts, and/or other financial instruments or related instruments or products, as any of these markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or other instruments, may respond or behave to changes in the various financial factors, factor models, technical factors fundamental factors, market factors, psychological factors, environmental factors, time factors, timing factors, as well as any of the herein-described markets, indices, stocks, bonds, securities, portfolios of securities, mutual funds, trusts, currencies, commodities, foreign exchange rates, interest rates, currencies, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other instrument which can serve as a factor or factors, and/or any other factor, event or occurrence (hereinafter referred to as “factor” or “factors”), and/or ratios of factors (hereinafter referred to as “factor ratios”), which can or which may be correlated to any of the markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or other instruments, described herein.

The present invention can provide information regarding past or expected behavior or price movements of markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any and/or other financial instruments or related instruments or products, in response to a state of a factor, a change in a factor, and/or an expected change in a factor.

For example, an individual investor can obtain information regarding past behavior of a stock he holds in response to a change in a market factor, such as, for example, a change in an interest rate.

The present invention can also be utilized to estimate the movement or behavior of a particular market, index, stock, bond, security, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instruments or related instruments or products, or any portfolio comprising any of the above, in response to a state of a factor, a change in a factor, and/or an expected change in a factor.

The present invention can also be utilized in order to project expected states of factors, changes in factors, and/or estimated changes in factors, from changes in any of the herein-described markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments or related instruments or products.

The present invention can also be utilized to provide information regarding real estate or real property and/or real estate investments or real property investments. The present invention can also be utilized to estimate the movement or behavior of the value of real estate or real property in response to a state of a factor, a change in a factor, and/or an expected change in a factor.

The present invention can also be utilized in order to provide notification to an individual investor of a state of a factor, a change in a factor, and/or an expected change in a factor. The present invention can also provide an individual with information regarding the expected or projected movements in and/or behavior of their investment portfolio, or of any of the markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or other financial instruments or related instruments or products, described herein which they may hold or own a position in or for which they may be interested in receiving information.

The present invention can provide information to any individual, consumer, individual investor, institutional investor, financial advisor, financial planner, broker, and/or dealer.

The apparatus and method of the present invention can be utilized in a network environment in order to effectuate any of the services described herein on, or over, any communication network.

The financial environment factors, environmental factors, agricultural factors, industrial factors, employment factors, economic factors, market-specific factors, initial public offerings-related factors, capitalization factors, investment factors, news factors, currency factors, foreign exchange factors, real estate factors, commodity factors, foreign exchange rate factors, interest rate factors, utility factors, energy factors, debt factors, credit factors, confidence factors, market indices factors, interest rate factors, inflation factors, price index factors, security factors, derivative factors, investor psychology factors, balance of payments and foreign trade factors, and/or any other factor, events, occurrences and/or phenomenon which can be, or which could possibly be, utilized in investment analysis.

The present invention can include at least one of more central processing computers, at least one or more individual computers, at least one or more financial institution or financial intermediary computers, at least one or more external information source computers, and at least one or more security issuer computers.

The database of the central processing computer can include any and/or all of the financial and/or other information needed for providing any of the financial information and/or investment information described herein, and/or for providing any of the functions of the present invention as described herein. In this regard, the database of the central processing computer can contain data and/or information for and/or regarding any of the herein described factors, factor ratios, markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, as well as any securities, portfolios of securities, mutual funds, trusts, markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other instruments, which serve as factors, factors which serve as factors.

The databases of the individual computers, the financial institution or financial intermediary computers, the external information source computers, and the security issuer computers, can contain any of the information stored in the database of the central processing computer as well as any data and/or information particular to the respective computer.

The present invention can provide financial information and/or investment information. The present invention can be utilized so as to obtain information regarding factors and/or changes in factors and how this information can provide useful financial and/or investment information.

The present invention can also be utilized so as to provide historical, statistical data and/or information regarding how markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other instruments, have been affected by, and/or have responded to, factors and/or changes in factors, as well as for providing forecasts of future behavior, price movement, market behavior, and/or fluctuation, of any of the herein-described markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any instruments or related instruments.

The present invention can also be utilized to ascertain a current status of a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or products, and/or to investigate, to check on, and/or to research, a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instruments or related instruments or products, so as to ascertain historical information regarding if, or how, the respective market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, has and/or could be affected by a factor and/or by a change in a factor.

The present invention can also be utilized to obtain information regarding a factor and any correlation, and/or effect, which that factor may have with, and/or on, a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instruments or product, the behavior of the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, and/or any value and/or price movement and/or fluctuation in the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, which can be correlated with the factor.

The present invention can also be utilized so as to provide notification to an individual of changes in a factor or factors as well as providing information concerning a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, which can be correlated with the factor or factors, with any changes in the respective factor or factors, historical information regarding any correlation between the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, and/or forecasts of behavior and/or value and/or price movement and/or fluctuation in, and/or regarding, the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product.

The present invention can also be utilized in order to provide protection and/or investment protection for a financial account, an investment account, a brokerage account, a commodities account, a consumer account, and/or any other account or portfolio. This can be accomplished by ascertaining a change in a factor or factors which can be correlated with the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, in the respective financial account, an investment account, a brokerage account, a commodities account, a consumer account, and/or any other account or portfolio, calculating possible affects of the change in the factor or factors, and providing notification of the change in the factor of factors, as well as the forecasted and/or possible affects on the respective financial account, an investment account, a brokerage account, a commodities account, a consumer account, and/or any other account or portfolio, which may be correlated with the change in the factor or factors.

The present invention can also be utilized to take action on behalf of the individual, such as to purchase, buy, sell, trade, exchange, borrow, take or obtain a position in, liquidate a position in, and/or perform and/or engage in any other activity relating to or regarding, any of the herein-described markets, indices, stocks, bonds, securities, portfolios of securities, mutual funds, trusts, currencies, commodities, foreign exchange rates, interest rates, currencies, real estate investment trusts, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other instruments, in response to a change in a factor or factors.

The present invention can also be utilized to provide notification to an individual of or regarding a news event, a news report, or a news story.

The present invention can also be utilized to provide or to disseminate advertisements. An advertisement or advertisements can also be included with any of the information, reports, notifications, or messages, described herein as being provided by the present invention.

The present invention can be utilized to provide subscription-based services and/or non-subscription-based services.

The central processing computer can be an integral component and/or system of a financial computer system, an on-line financial computer system, an investment computer system, a brokerage computer system, commodity computer system, and/or an on-line brokerage computer system.

Each of the respective computers can communicate with one another via electronic submissions, electronic form submissions and/or transmissions, e-mail transmissions, facsimile transmissions, telephone messages, telephone calls, physical mail delivery, and/or via any other suitable communication technique, medium, or method.

Intelligent agents, software agents, mobile agents, and/or related technologies, can be utilized in conjunction with the present invention and can be programmed and/or designed to act on behalf of the respective individual, financial institution or financial intermediary, external information source, and/or security issuer, so as to perform searches, information updates, calculations, forecasting, and/or any other operations.

The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, and/or any of the communications, which are described herein, between any of the parties which utilize the present invention.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, as well as in, or on any internets and/or intranets, the Internet, the World Wide Web, cable television, digital television, cellular communication, and/or any other suitable communication network or system.

The apparatus and method of the present invention can be utilized in conjunction with a wireless communication network or system, a wired or line-connected communication network or system, or any hybrid or combination of a wireless communication network or system and a wired or line-connected communication network or system.

The data and/or information stored in any of the databases utilized in the apparatus of the present invention can be continuously updated so as to store the latest values for the data and/or information and can be made available for future calculations, analyses and/or processing.

The present invention can be utilized in conjunction with various cryptographic methods and technologies in order to provide security for any of the data and/or information described herein as well as to provide security for any of the communications described herein as taking place between any of the respective parties described herein. In this manner, any data and/or information as well as any communications relating thereto, along with any of the accounts serviced by the apparatus and method of the present invention, can be secured by utilizing various cryptographic methods and technologies.

Accordingly, it is an object of the present invention to provide an apparatus and a method for providing financial information, investment information, and/or any other related information.

It is another object of the present invention to provide an apparatus and a method for providing financial information and/or investment information in a network environment.

It is still another object of the present invention to provide an apparatus and a method for providing financial information, investment information, and/or any other related information for, or regarding, financial markets, market indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any instruments or related instruments.

It is yet another object of the present invention to provide an apparatus and a method for providing financial information and/or investment information which provides notification of financial events and/or occurrences.

It is another object of the present invention to provide an apparatus and a method for providing financial information and/or investment information which provides historical information, statistical information and/or forecasting information.

It is still another object of the present invention to provide an apparatus and a method for providing financial information and/or investment information which utilizes any of the factors described herein, financial factors, factor models, factor ratios, markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any and/or other financial instruments or related instruments or products, which serve as factors, factors which serve as factors, financial variables, financial events, and/or related occurrences.

It is yet another object of the present invention to provide an apparatus and a method for providing financial information and/or investment information which provides information regarding the behavior of financial markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any and/or other financial instruments or related instruments or products.

It is another object of the present invention to provide an apparatus and a method for providing financial information and/or investment information which utilizes financial factors, factor models, technical factors fundamental factors, market factors, psychological factors, environmental factors, utility factors, commodity factors, energy factors, time factors, timing factors, real estate factors, and/or any other factor, event or occurrence.

It is still another object of the present invention to provide an apparatus and a method for providing financial information and/or investment information which provides information regarding past or expected behavior, prices, price movements, expected changes, expected movements, and/or fluctuations, in, or regarding, markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any and/or other financial instruments or related instruments or products, in response to a state of a factor, a change in a factor, a factor ratio, an expected change in a factor, and/or an expected change in a factor ratio.

It is yet another object of the present invention to provide an apparatus and a method for providing financial information and/or investment information which provides estimates of the movement or behavior of a particular market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, in response to a state of a factor, a change in a factor, a factor ratio, an expected change in a factor, and/or an expected change in a factor ratio.

It is another object of the present invention to provide an apparatus and a method for providing financial information and/or investment information which provides projected states of factors, changes in factors, estimated changes in factors, states of factor ratios, changes in factor ratios, and/or estimated changes in factor ratios.

It is still another object of the present invention to provide an apparatus and a method for providing financial information and/or investment information which provides notification to an individual investor of a state of a factor, a change in a factor, an expected change in a factor, a state of a factor ratio, a change in a factor ratio, and/or an estimated change in a factor ratio.

It is yet another object of the present invention to provide an apparatus and a method for providing financial information and/or investment information which provides information regarding projected movements in, and/or behavior of, a market, an index, a stock, a bond, a security, a portfolio of securities, a mutual fund, a trust, a currency, a commodity, a foreign exchange rate, an interest rate, a real estate investment trust, real estate, a real property, a utility service, a utility product, an energy service, an energy product, a telecommunication service, a telecommunication product, a debt product, a credit product, a credit derivative product, and/or any other financial instrument or related instrument or product.

It is another object of the present invention to provide an apparatus and a method for providing financial information and/or investment information which provides information regarding financial accounts, investment accounts, brokerage accounts, commodities accounts, consumer accounts, and/or any other accounts or portfolios.

It is still another object of the present invention to provide an apparatus and a method for providing financial information and/or investment information which utilizes financial environment factors, environmental factors, agricultural factors, commodity factors, industrial factors, utility factors, energy factors, debt factors, credit factors, employment factors, economic factors, market-specific factors, news factors, real estate factors, and/or any other factors which may be correlated with markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any and/or other financial instruments or related instruments or products.

It is yet another object of the present invention to provide an apparatus and a method for providing financial information and/or investment information which provides information regarding a current status of, research regarding, and/or historical information regarding, markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any, and/or other financial instruments or related instruments or products, and/or a correlation between markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any and/or other financial instruments or related instruments or products, and a factor, a factor ratio, and/or any other market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product.

It is another object of the present invention to provide an apparatus and a method for providing financial information and/or investment information which provides notification to an individual regarding a change in a factor, a change in a factor ratio, and/or market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, as well as providing information regarding a correlation between a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product, and a factor, factor ratio, and/or another market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, and/or any and/or other financial instrument or related instrument or product.

It is still another object of the present invention to provide an apparatus and a method for providing financial information and/or investment information which provides protection and/or investment protection for a financial account, a brokerage account, an investment account, a commodity account, a consumer account, and/or any other account or portfolio.

It is yet another object of the present invention to provide an apparatus and a method for providing financial information and/or investment information which can be utilized to take action in making a transaction on or in an individual's account, on behalf of the individual.

It is another object of the present invention to provide an apparatus and a method for providing financial information and/or investment information which utilizes intelligent agents, software agents, and/or mobile agents, which can be programmed and/or designed to perform any operation and/or function described as being performed by the present invention.

It is still another object of the present invention to provide an apparatus and a method for providing financial information and/or investment information which can be programmed to be self-activating and/or activated automatically.

It is yet another object of the present invention to provide an apparatus and a method for providing financial information and/or investment information which can be utilized in conjunction with any communication network or system.

It is another object of the present invention to provide an apparatus and a method for providing financial information and/or investment information which can be utilized in conjunction with a wireless communication network or system, a wired or line-connected communication network or system, or any combination of a wireless communication network or system and a wired or line-connected communication network or system.

It is still another object of the present invention to provide an apparatus and a method for providing financial information and/or investment information which can be utilized in conjunction with various cryptographic technologies in order to provide account information and/or account security.

It is yet another object of the present invention to provide an apparatus and method for providing information regarding real estate or real property and/or a real estate investment(s) or a real property investment(s).

It is yet another object of the present invention to provide an apparatus and method for providing information regarding estimated or predicted movement in, or behavior of, the value of real estate or real property in response to a news event, a state of a factor, a change in a factor, and/or an expected change in a factor.

It is yet another object of the present invention to provide an apparatus and a method for providing notification to an individual of or regarding a news event, a news report, or a news story.

It is still another object of the present invention to provide an apparatus and a method for providing or for disseminating an advertisement or advertisements.

Other objects and advantages of the present invention will be apparent to those skilled in the art upon a review of the Description of the Preferred Embodiment taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of the apparatus of FIG. 1, in block diagram form;

FIG. 3 illustrates the individual computer of the apparatus of FIG. 1, in block diagram form;

FIG. 4 illustrates the financial institution or financial intermediary computer of FIG. 1, in block diagram form;

FIG. 5 illustrates the external information source computer of FIG. 1, in block diagram form;

FIG. 6 illustrates the security issuer computer of FIG. 1, in block diagram form;

FIG. 7 illustrates a preferred embodiment operation of the apparatus of FIG. 1, in flow diagram form;

FIG. 8 illustrates another preferred embodiment operation of the apparatus of FIG. 1, in flow diagram form;

FIG. 9 illustrates another preferred embodiment operation of the apparatus of FIG. 1, in flow diagram form; and

FIG. 10 illustrates another preferred embodiment operation of the apparatus of FIG. 1, in flow diagram form.

### DESCRIPTION OF THE PREFERRED EMBODIMENTS

The apparatus and method of the present invention provides an apparatus and a method for providing financial information, investment information, notification of financial events, financial forecasting, and/or investor or consumer information. The present invention also provides an apparatus and a method for providing financial information, investment information, notification of financial events, financial forecasting, and/or investor or consumer information, by utilizing financial factors, factors, factor models, factor ratios, financial variables, financial events, news events, and/or related occurrences, in a network environment.

The present invention utilizes the technologies and advances in information technology and in communication technology in order to provide the herein-described information, services, and/or products, in a network environment.

While described as being utilized in a network environment, the apparatus and method of the present invention can also be utilized in a non-network environment such as, for example, on a stand alone computer or computer system.

The present invention can be utilized so as to provide information regarding the behavior of any of the financial markets, market indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, as any of these markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, may respond or behave to changes in the various financial factors, factor models, technical factors fundamental factors, market factors, psychological factors, environmental factors, utility factors, energy factors, time factors, timing factors, and/or any other factor, event or occurrence (hereinafter referred to as “factor” or “factors”), which can or which may be correlated to any of the markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, described herein.

The present invention can provide information regarding past or expected behavior, prices, price movements, expected price movements, and/or fluctuations, of markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, in response to a state of a factor, a change in a factor, an expected change in a factor, a state of a factor ratio, a change in a factor ratio, and/or an expected change in a factor ratio.

For example, an individual investor can obtain information regarding past behavior of a stock he holds in response to a change in a market factor, such as, for example, a change in an interest rate.

The present invention can also be utilized to estimate the movement or behavior of a particular market, index, stock, bond, security, portfolio of securities, mutual fund, trust, currency, commodity, foreign exchange rate, interest rate, utility service, utility product, energy service, energy product, telecommunication service, telecommunication product, debt product, credit product, credit derivative product, and/or any and/or other financial instrument or related instrument or product, or any portfolio comprising any of the above, in response to a state of a factor, a change in a factor, an expected change in a factor, a state of a factor ratio, a change in a factor ratio, and/or an expected change in a factor ratio.

The present invention can also be utilized in order to project expected states of factors, changes in factors, estimated changes in factors, states of factor ratios, changes in factor ratios, and/or estimated changes in factor ratios, from changes in any of the herein-described markets, indices, stocks, bonds, securities, portfolios of securities, mutual funds, trusts, currencies, commodities, foreign exchange rates, interest rates, currencies, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments.

The present invention can also be utilized in order to provide notification to an individual investor of a state of a state of a factor, a change in a factor, an estimated change in a factor, a state of a factor ratio, a change in a factor ratio, and/or an estimated change in a factor ratio. The present invention can also provide an individual with notification of projected movements in, and/or behavior of, any of the herein-described markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, which may be of interest to the individual.

The present invention can also provide an individual with notification of information regarding his or her investment portfolio or other markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, in which he or she may hold a position.

The present invention can also provide notification to an individual of or regarding a news event, a news report, or a news story.

The present invention can also be utilized to provide or to disseminate advertisements. An advertisement or advertisements can also be included with any of the information, reports, notifications, or messages, described herein as being provided by the present invention.

The present invention can provide information to any individual, consumer, individual investor, brokerage account owner, brokerage account holder, institutional investor, financial advisor, financial planner, broker, commodities broker, energy broker, utility broker, and/or any respective dealer.

Applicant hereby incorporates by reference herein the subject matter and teachings of U.S. Provisional Patent Application Ser. No. 60/150,410 which teaches and discloses an apparatus and method for providing financial information and/or investment information. Applicant also hereby incorporates by reference herein the subject matter and teachings of U.S. Provisional Patent Application Ser. No. 60/218,265 which teaches and discloses an apparatus and method for providing financial information and/or investment information.

In the preferred embodiment, the present invention can be utilized to provide financial information and/or investment information in conjunction with, and/or in conjunctions with services provided by, banks, financial institutions, securities brokers, bond brokers, commodities brokers, energy brokers, utility brokers, financial managers, securities managers, bond managers, commodities managers, energy managers, utility managers, financial accounts, brokerage accounts, on-line brokerage accounts, securities accounts, bond accounts, commodities accounts, energy accounts, utility accounts, investment banks, and/or insurance companies.

In the preferred embodiment, the present invention can also be utilized in conjunction with traditional brokerages and/or in conjunction with on-line brokerages who or which operate over the Internet, the World Wide Web, cable television, digital television, cellular communication, and/or any other communication network or system.

Any of the data and/or information described herein as being provided by the present invention can include, but not be limited to, text information and/or material, graphical information and/or material, charts, tables, video information and/or video material, images, and/or audio information and/or audio material.

The apparatus and method of the present invention can be utilized in a network environment in order to effectuate any of the services described herein on, or over, any communication network. The present invention can also be utilized in conjunction with stand alone computer systems.

As used herein, the terms “security”, “stock”, “bond”, or the plural of same, refer to any financial security, stock, bond, equity instrument, bond instrument, debt instrument, and/or any other financial instrument or security, as well as any portfolio of securities, stocks, bonds, mutual funds, trusts, and/or any other financial instrument or related instrument or product. As defined herein, the terms “market”, “index”, or the plural of same, refer to any financial markets and/or financial market index or financial market indices, domestic or foreign.

As used herein, the term “currency” or the plural of same, refers to any currency or monetary unit or denomination, domestic or foreign. As used herein, the term “foreign exchange rate”, or the plural of same, refers to any foreign exchange rates for or regarding any currencies, domestic or foreign.

As used herein, the term “commodity”, or the plural of same, refers to any commodities which can be the subject of commerce and can include, but which is not limited to, agricultural commodities, food commodities, energy commodities, utility commodities, utility services, utility products, energy services, energy products, telecommunication services, telecommunication products, communication bandwidth services, communication bandwidth products, oil products, natural gas products, wireless communication services, and/or any other commodities which can be sold, purchased, traded, and/or exchanged, on any commodities exchange.

As used herein, the term “interest rate”, or the plural of same, refers to any interest rate or interest rates which are offered by any lenders, public or private, domestic or foreign.

As used herein, the term “derivative”, or the plural of same, refers to any options, futures, forwards, options contracts, futures contracts, forwards contracts, energy contracts, utility contracts, commodity contracts, foreign exchange rate contracts, interest rate contracts, credit instruments, credit derivatives, credit product contracts, debt instruments, debt derivatives, debt instruments, LEAPS, etc., and/or any other derivative instruments which are, or which can be, associated with any of the markets, indices, stocks, bonds, securities, portfolios of securities, mutual funds, trusts, currencies, commodities, foreign exchange rates, interest rates, currencies, real estate investment trusts, real estate, real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, described herein.

The term “derivative”, or the plural of same, also refers to, and/or includes any equity, debt, financial, and/or commodity derivatives including any derivatives identified and/or described in The Handbook of Equity Derivatives, Jack Clark Francis, Wiley, 2000, The Handbook of Credit Derivatives, Jack Clark Francis et, al. McGraw Hill, 1999, and Credit Derivatives—Trading & Management of Credit & Default Risk, Satyajit Das, Wiley, 1998.

As used herein, the terms “utility product”, “utility service”, or the plural of same, refer to any utility products and/or services, electrical utility products, electrical utility services, electrical service capacity, electrical power capacity, nuclear utility products, nuclear utility services, gas utility products, gas utility services, natural gas utility products, natural gas utility services, heating utility products, heating utility services, and/or any oil, petroleum, fuel, air, water, compressed gases, compressed liquids, products and/or services, and/or any other products and/or services, and/or any contracts and/or capacity for, or related to, same, and/or any other utility products and/or services, and/or contracts or capacity for, or related to, same which can be the subject of commerce.

As used herein, the terms “energy product”, “energy service”, or the plural of same, refer to any energy products and/or services, fuel, fuels, fossil fuels, petroleum related fuels, natural gas fuels, electrical energy products, services, and/or capacity, nuclear products, services, and/or capacity, geothermal products, services, and/or capacity, steam energy products, services, and/or capacity, fuel products and/or services, including oil, gas, petroleum, natural gas, compressed gas, compressed liquid, fuels, products, services, and/or capacity, and/or any contracts and/or capacity for, or related to, same, and/or any other fuel, energy, and/or related products, services, contract and/or capacity, for, or related to, same, and/or any other fuel and/or energy products, services, and/or capacity, which can be the subject of commerce.

As used herein, the terms “telecommunication product”, “telecommunication service”, or the plural of same, refer to any telecommunication products and/or services, communication products and/or services, wireless communications products and/or services, frequencies, bandwidth capacity, frequency spectrum ranges, wireless frequencies, wireless bandwidth, wireless frequency spectrum ranges, non-wireless frequencies, non-wireless bandwidth, non-wireless frequency spectrum ranges, cable television frequencies, cable television bandwidth, cable television frequency spectrum ranges, and/or any other communications products, services, easements, capacity, and/or contracts for, or related to, same, and/or any other telecommunications and/or communications products, services, easements, capacity, and/or contracts for, or related to, same which can be the subject of commerce.

Applicant hereby incorporates by reference herein the subject matter and teachings of The Handbook of Equity Derivatives, Jack Clark Francis, Wiley, 2000, The Handbook of Credit Derivatives, Jack Clark Francis et, al. McGraw Hill, 1999, and Credit Derivatives—Trading & Management of Credit & Default Risk, Satyajit Das, Wiley, 1998.

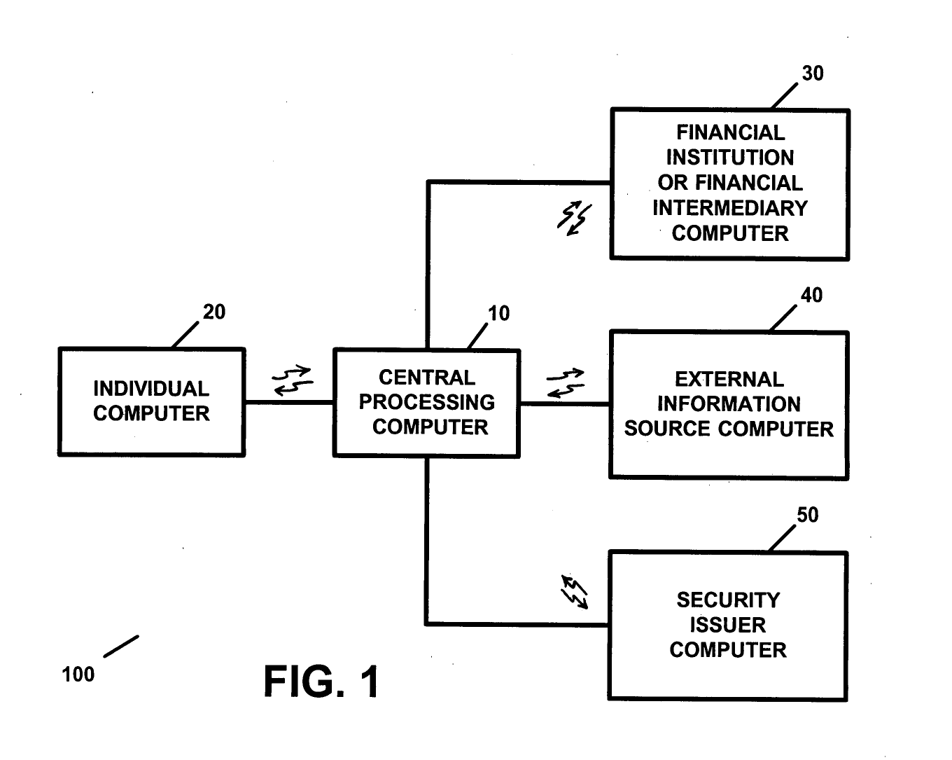

FIG. 1 illustrates a preferred embodiment of the apparatus of the present invention which is designated generally by the reference numeral 100. In FIG. 1, the apparatus 100 includes a central processing computer or server computer 10. The central processing computer 10 provides control over the apparatus 100 and performs various processing operations for providing the various services described herein. The central processing computer 10 also provides various services described herein for the various computers associated with individual investors, financial institutions and/or financial intermediaries, and computers associated with the various external information sources.

The central processing computer 10, in the preferred embodiment, can be any suitable computer, network computer, or computer system, for providing service for the various computers associated with the individual investors, financial institutions and/or financial intermediaries, who or which utilize the present invention, and computers associated with the various external information sources.

In the preferred embodiment, any number of central processing computers 10 can be utilized in order to provide the servicing functions described herein. The central processing computer(s) 10 may be linked to other central processing computers or may be stand alone devices. Each central processing computer 10 may be a network computer, a personal computer, and/or any other communication device, suitable for allowing the central processing computer 10 to interact with any other central processing computer(s) 10 and/or with any of the other computers 20, 30, 40, and/or 50, described herein.

A given central processing computer 10 may service a particular geographic area or certain individual investors, financial institutions and/or financial intermediaries, who or which utilize the present invention, and/or computers associated with the various external information sources. A central processing computer 10 may also be dedicated to service any one or group of the above described individuals and/or entities.

The apparatus 100, in the preferred embodiment, also includes one or more individual computers 20, with each individual computer 20 being associated with an individual investor. An individual computer 20 may also be associated with a number of individual investors, depending upon the desired application.

Each individual computer 20 may be a personal computer, a network computer, and/or any other communication device suitable for allowing the individual computer 20 to interact with the central processing computer(s) 10 and/or any of the other computers 20, 30, 40, and/or 50 described herein. Each individual computer 20 can be utilized to transmit information to the central processing computer 10 and to receive information from the central processing computer 10 via the communication network.

The individual computer 20 can be a personal computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and/or a watch. In the present invention, any number of individual computers 20 may be utilized. In the present invention, each individual or entity utilizing the present invention may have one or more individual computers 20 associated therewith.

The apparatus 100, in the preferred embodiment, also includes one or more financial institution or financial intermediary computers 30, with each financial institution or financial intermediary computer being associated with a financial institution or financial intermediary.

A financial intermediary computer 30 can be associated with and/or can be utilized by any issuer, seller, broker, and/or dealer, of and/or for, any of the markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, described herein.

Each financial institution or financial intermediary computer 30 may also be associated with a number of financial institutions or financial intermediaries, depending upon the desired application.

Each financial institution or financial intermediary computer 30 may be a network computer, a personal computer, and/or any other communication device suitable for allowing the financial institution or financial intermediary computer 30 to interact with the central processing computer(s) 10 and/or any of the other computers 20, 30, 40, and/or 50 described herein. Each financial institution or financial intermediary computer 30 can be utilized to transmit information to the central processing computer 10 and to receive information from the central processing computer 10 via the communication network.

The financial institution or financial intermediary computer 30 can be a personal computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and/or a watch. In the preferred embodiment, any number of financial institution or financial intermediary computers 30 may be utilized. In the present invention, each financial institution or financial intermediary utilizing the present invention may have one or more financial institution or financial intermediary computers 30 associated therewith.

The apparatus 100, in the preferred embodiment, also includes one or more external information source computers 40, with each external information source computer 40 being associated with an external information source. Each external information source computer 40 may also be associated with a number of external information sources, depending upon the desired application.

Each external information source computer 40 may be a network computer, a personal computer, and/or any other communication device suitable for allowing the external information source computer 40 to interact with the central processing computer(s) 10 and/or any of the other computers 20, 30, 40, and/or 50 described herein. Each external information source computer 40 can be utilized to transmit information to the central processing computer 10 and to receive information from the central processing computer 10 via the communication network.

The external information source computer 40 can be a personal computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and/or a watch. In the preferred embodiment, any number of external information source computers 40 may be utilized. In the present invention, each external information source utilizing, and/or providing information to, the present invention may have one or more external information source computers 30 associated therewith.

The apparatus 100, in the preferred embodiment, also includes one or more security issuer computer 50, with each security issuer computer 50 being associated with a security issuer which may be any entity which issues stocks, bonds, securities, portfolios of securities, mutual funds, trusts, derivative, and/or any other financial security.

A security issuer computer 50 can also be associated with and/or can be utilized by any issuer, seller, broker, and/or dealer, of and/or for, any of the markets, indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, described herein.

Each security issuer computer 50 may also be associated with a number of security issuers, depending upon the desired application.

Each security issuer computer 50 may be a network, a personal computer, and/or any other communication device suitable for allowing the security issuer computer 50 to interact with the central processing computer(s) 10 and/or any of the other computers 20, 30, 40, and/or 50 described herein. Each security issuer computer 50 can be utilized to transmit information to the central processing computer 10 and to receive information from the central processing computer 10 via the communication network.

The security issuer computer 50 can be a personal computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and/or a watch. In the preferred embodiment, any number of security issuer computers 50 may be utilized. In the present invention, each security issuer utilizing, and/or providing information to, the present invention may have one or more security issuer computers 50 associated therewith.

The terms “operator”, “user”, or the plural versions of same, as defined herein, refer to any individual, company, business entity, and/or agent thereof, who or which operate and/or utilize any of the central processing computers 10, the individual computers 20, the financial institution or financial intermediary computers 30, the external information source computers 40, and/or the security issuer computers 50, described herein, in order to utilize, administer, operate, manage, and/or to facilitate the utilization, administration, operation, management, of the present invention and/or any of its components, functions, services, etc.

The terms “individual”, “investor”, or the plural versions of same, as defined herein, refer to any individuals, investors, account holders, account owners, account managers, and/or the agents, brokers, money managers, portfolio managers for these individuals and/or investors, banks, bankers, commodity trading firms, financial institutions, insurance companies, etc., who or which utilize the individual computer 20 described herein in order to utilize, and/or to facilitate the utilization of, the present invention.

The terms “financial institution”, “financial intermediary”, or the plural versions of same, as defined herein, refer to any financial institutions, banks, savings banks, commercial banks, investment banks, investment companies, brokers, dealers, traders, commodity brokers, commodities traders, on-line brokers, brokerages, on-line brokerages mutual funds, mutual fund companies, insurance companies, financial intermediary, individual, company and/or other entity, and/or any other financial institution or financial intermediary known to those skilled in the financial and investment arts, who or which utilize the financial institution or financial intermediary computer 30 described herein in order to utilize, and/or to facilitate the utilization of, the present invention.

The term “external information source” or the plural versions of same, as defined herein refers to any information sources, financial information sources, news services, financial news services, stock exchanges, bond exchanges, commodities exchanges, securities, portfolios of securities, mutual funds, trusts, exchanges, options exchanges, futures exchanges, swaps exchanges, derivatives exchanges, securities, portfolios of securities, mutual funds, trusts, information sources, including both public sources and private sources, weather services, financial information sources, insurance information sources, government agencies, including Federal, state, local, and foreign agencies, any individuals, companies, and/or entities, which can provide financial and/or investment information, and/or any other sources of information, financial, investment, and/or otherwise, and/or advertisers or suppliers of marketing information, which can or may be necessary and/or desirable in performing any of the functions and/or operations described herein, who or which utilize the external information source computer 40 described herein in order to utilize, and/or to facilitate the utilization of, the present invention.

The term “security issuer”, or the plural use of same, as defined herein, refers to any companies, business entities, private companies, privately held companies, public companies, publicly traded companies, private sector companies, public sector companies, governments, federal governments, state governments, local governments, municipalities, foreign governments, foreign country subdivision governments, and/or any agencies of any of the above-described governments and/or municipalities, individual, companies and/or entities, who or which issue, sell, trade, broker, and/or deal with, any of the stocks, bonds, securities, portfolios of securities, mutual funds, trusts, currencies, commodities, foreign exchange rates, interest rates, currencies, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and/or any derivatives, options, futures, forwards, and/or other contracts associated therewith and/or related thereto, and/or investment vehicles of any kind, who or which utilize the security issuer computer 50 described herein in order to utilize, and/or to facilitate the utilization of, the present invention.

The terms “factor”, “financial factor”, or the plural version of same, as the term is utilized herein, refers to any and all of the factors, financial factors, types of factors, factor ratios, securities, portfolios of securities, mutual funds, trusts, which may serve as factors, factors which may serve as factors, securities, portfolios of securities, mutual funds, trusts, being considered for their security characteristics, and/or factors being considered for their security characteristics.

The factors and/or financial factors can include, but are not limited to, any of the various and herein-described factors, financial factors, market factors, company-specific factors, security issuer-specific factors, time factors, industry-specific factors, real estate factors, commodity factors, sector-specific factors, financial environment factors, environmental factors, agricultural factors, industrial factors, utility factors, energy factors, credit factors, debt factors, employment factors, economic factors, market-specific factors, initial public offerings-related factors, capitalization factors, investment factors, news factors, currency factors, commodities, foreign exchange factors, foreign exchange rate factors, confidence factors, market indices factors, interest rate factors, inflation factors, price index factors, security factors, derivative factors, investor psychology factors, domestic and international trade information, including trade indicators, balance of payments indicators, trade deficit information and indicators, trade surplus information and indicators, foreign trade factors, and/or any other factor, events, occurrences and/or phenomenon which can be, or which could possibly be, utilized in investment analysis, planning and/or forecasting and/or in financial analysis, planning and/or forecasting.

The factors and/or financial factors can also include any of the herein-described financial markets, market indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments.

Each of the central processing computer(s) 10, each of the individual computer(s) 20, each of the financial institution or financial intermediary computers 30, each of the external information source computers 40, and/or each of the security issuer computer 50, described herein can transmit information to, and receive information from, each central processing computer 10.

In a similar manner, each of the individual computer(s) 20 can transmit information to, and receive information from, any of the central processing computers 10, any of the individual computers 20, any of the financial institution or financial intermediary computers 30, any of the external information source computers 40, and any of the security issuer computers 50. Similarly, each of the financial institution or financial intermediary computers 30 can transmit information to, and receive information from, any of the individual computer(s) 20, any of the financial institution or financial intermediary computers 30, any of the external information source computers 40, and any of the security issuer computers 50.

In a similar manner, each of the external information source computers 40 can transmit information to, and receive information from, any of the individual computer(s) 20, any of the financial institution or financial intermediary computers 30, any of the external information source computers 40, and any of the security issuer computers 50. Further, each of the security issuer computers 50 can transmit information to, and receive information from, any of the individual computer(s) 20, any of the financial institution or financial intermediary computers 30, any of the external information source computers 40, and any of the security issuer computers 50.

The central processing computer(s) 10, the individual computer(s) 20, the financial institution or financial intermediary computer(s) 30, the external source computer(s) 40, and/or the security issuer computer(s) 50, can communicate with one another, and/or be linked to one another, over a communication network and/or a wireless communication network.

The apparatus and method of the present invention can be utilized on, over, and/or in conjunction with, a wireless communication network or system, a wired or line-connected communication network or system, or any combination of a wireless communication network or system and a wired or line-connected communication network or system.

In the preferred embodiment, the present invention is utilized on, and/or over, the Internet and/or the World Wide Web. The present invention can also be utilized on, and/or over, a cable television network or system, digital television network or system, and/or a cellular communication network or system. The present invention, in the preferred embodiment, can also utilize wireless Internet and/or World Wide Web services, equipment and/or devices. The central processing computer(s) 10, in the preferred embodiment, has a web site or web sites associated therewith.

Although the Internet and/or the World Wide Web is the preferred communication system and/or medium utilized, the present invention, in all of the embodiments described herein, can also be utilized with any appropriate communication systems including, but not limited to, network communication systems, telephone communication systems, wired or line connected communications systems, wireless communications systems, cellular communication systems, digital communication systems, personal communication systems, personal communication services (PCS) systems, satellite communication systems, broad band communication systems, bluetooth communications systems, low earth orbiting (LEO) satellite systems, and/or public switched telephone networks or systems.

In the preferred embodiment, each of the central processing computer(s) 10, the individual computer(s) 20, the financial institution or financial intermediary computer(s) 30, the external source computer(s) 40, and/or the security issuer computer(s) 50, can be equipped with any and/or all hardware and/or software necessary and/or desirable for facilitating the operation of the apparatus 100 as described herein.

In the preferred embodiment, each of the central processing computer(s) 10, the individual computer(s) 20, the financial institution or financial intermediary computer(s) 30, the external source computer(s) 40, and/or the security issuer computer(s) 50, can transmit and/or receive data and/or information using TCP/IP, as well as any other Internet and/or World Wide Web, protocols.

In the preferred embodiment, each of the central processing computer(s) 10, the individual computer(s) 20, the financial institution or financial intermediary computer(s) 30, the external source computer(s) 40, and/or the security issuer computer(s) 50, can be utilized by any entities, foreign and domestic, in order to facilitate an international financial information apparatus or center.

The central processing computer(s) 10, the individual computer(s) 20, the financial institution or financial intermediary computer(s) 30, the external source computer(s) 40, and/or the security issuer computer(s) 50, in the preferred embodiment, can be linked directly or indirectly with any other central processing computer(s) 10, individual computer(s) 20, financial institution or financial intermediary computer(s) 30, external source computer 40, and/or security issuer computer 50. Any of the herein-described computers may communicate with any other computer in a bi-directional manner.

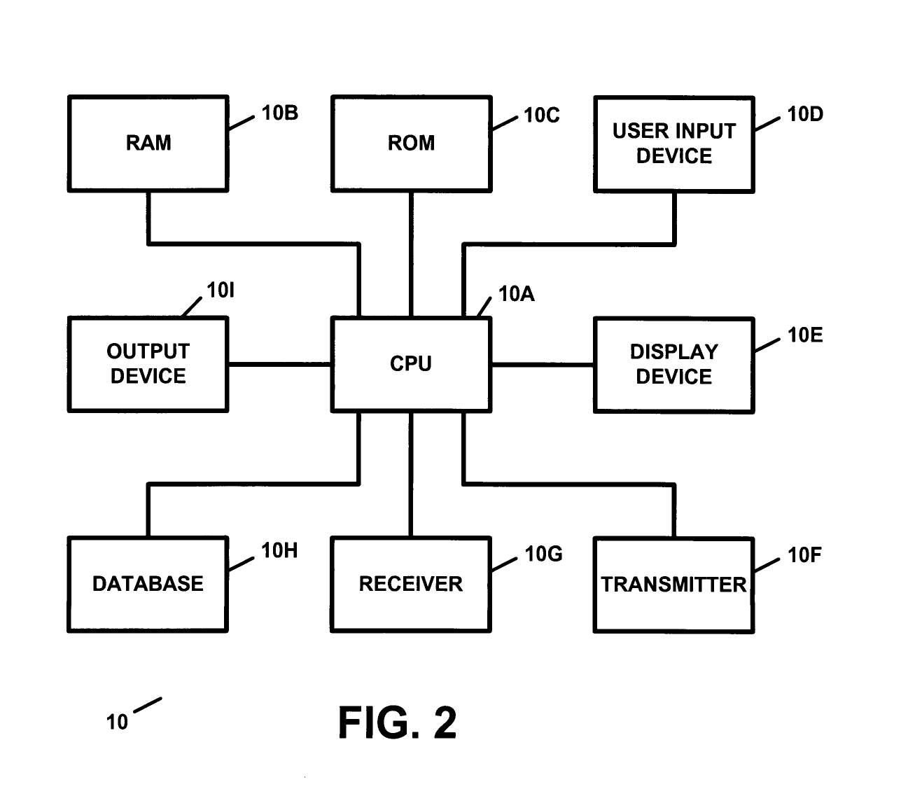

FIG. 2 illustrates the central processing computer 10, in block diagram form. The central processing computer 10, in the preferred embodiment, is a network computer or computer system which is utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, etc., if desired, which input device(s) is also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computer(s) 10, individual computer(s) 20, financial institution or financial information computer(s) 30, external information source computer(s) 40, and/or security issuer computer(s) 50, which may be utilized in conjunction with the present invention. The central processing computer 10 also includes a receiver 10G, for receiving signals and/or data and/or information from any one or more of the central processing computer(s) 10, individual computer(s) 20, financial institution or financial information computer(s) 30, external information source computer(s) 40, and/or security issuer computer(s) 50, which may be utilized in conjunction with the present invention.

The database 10H can include data and/or information regarding factors, financial factors, market factors, company-specific factors, security issuer-specific factors, time factors, industry-specific factors, sector-specific factors, financial environment factors, environmental factors, agricultural factors, commodity factors, industrial factors, employment factors, economic factors, market-specific factors, initial public offerings-related factors, capitalization factors, investment factors, news factors, currency factors, commodities, foreign exchange factors, foreign exchange rate factors, confidence factors, market indices factors, interest rate factors, inflation factors, price index factors, security factors, derivative factors, investor psychology factors, real estate factors, real property factors, domestic and international trade information, including trade indicators, balance of payments indicators, trade deficit information and indicators, trade surplus information and indicators, foreign trade factors, and/or any other factor, events, occurrences and/or phenomenon which can be, or which could possibly be, utilized in investment analysis, planning and/or forecasting, and/or in financial analysis, planning and/or forecasting.

Values, changes, percent changes, correlational relationships, and/or other measures, for any and/or all of the factors, financial factors, measurements, events, occurrences, and/or phenomenon (hereinafter referred to as “factors”), described herein, are stored in the database 10H in such a manner that any values, changes, percent changes, correlational relationships, and/or other measures of any factor(s), can be correlated with the values, changes, percent changes, correlational relationships of any of the financial markets, market indices, stocks, bonds, debt securities, securities, equity securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, as well as be correlated with any and/or all of the other factors utilized in conjunction with the present invention.

The financial environment factors, environmental factors, agricultural factors, industrial factors, utility factors, energy factors, credit factors, debt factors, employment factors, economic factors, market-specific factors, initial public offerings-related factors, capitalization factors, investment factors, news factors, currency factors, commodity factors, real estate factors, real property factors, foreign exchange factors, foreign exchange rate factors, confidence factors, market indices factors, interest rate factors, inflation factors, price index factors, security factors, derivative factors, investor psychology factors, balance of payments and foreign trade factors, as well as any of the financial markets, market indices, stocks, bonds, securities, portfolios of securities, mutual funds, trusts, currencies, commodities, foreign exchange rates, interest rates, currencies, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, which can be utilized as factors, and/or any other factor, events, occurrences and/or phenomenon which can be, or which could possibly be, utilized in investment analysis, can include, but not be limited, to the following factors: interest rates for benchmark as well as non benchmark government, corporate, or commercial debt, domestic and/or foreign, including U.S. treasury securities, portfolios of securities, mutual funds, trusts, zero coupon bonds, inflation-indexed securities, portfolios of securities, mutual funds, trusts, LIBOR, agency securities, portfolios of securities, mutual funds, trusts, municipal securities, portfolios of securities, mutual funds, trusts, including bonds or securities, portfolios of securities, mutual funds, trusts, issued by FNMA, Federal Home Loan Bank, Federal farmer credit bank, Student Loan Marketing, World Bank bonds, Financing Corp., Inter-American Development Bank, GNMA, Tennessee Valley Authority, Resolution Funding Corp., foreign government and/or corporate bonds, fixed and/or variable annuities, money market rates, life accounts, variable life accounts, tax free and/or taxable money funds, open end funds, closed end funds, Lipper Mutual Fund performance, equity as well as debt securities, portfolios of securities, mutual funds, trusts, option volumes, futures volumes, commodities, foreign exchange rates, commodities, including fibers, financial and money, food, foreign currencies, fuels, grain and feed, livestock and/or meat, lumber, rubber, metals, precious metals, oil, natural gas, petroleum, gasoline, electric power, communications services, telecommunications services, water, hydroelectric power, and/or any other commodities, utility products and/or services, energy products and/or services, communications products and/or services, and/or telecommunications products and/or services, consumer price index, producer price index, new housing starts, inflation rates, consumer confidence index, durable goods orders, purchasing agents reports, investor psychology indexes, measures and/or reports, news reports, events, and/or activities, financial news reports, events, and/or activities, including, but not limited to news services such as ABC, NBC, CBS, FOX, Value Line, Reuters, Dow Jones, Bloomberg, Associated Press, CNN, CNNFN, financial news sources, and/or other news sources, stock exchange information and stock exchange indices, domestic and foreign, including, but not limited to, NYSE, AMEX, NASD, NASDAQ, CBOE, CBOT, NY Mercantile, Chicago Mercantile, U.S. Dollar value, German Deutschemark value, Japanese Yen value, commodities futures, financial futures, deferred asset funds, equity financing, financial options, guaranteed investment contracts, index futures, junk bonds and junk bond rate, Moody's and/or Standard & Poors ratings, money rates, including U.S. and foreign, foreign exchange rates, commodity prices, NASDAQ small cap issues, U.S. regional markets, bond redemption rates, bond and/or debt default rates, loan default rates and/or information, mortgage default rates and/or information, foreclosure rates and/or information, mortgage foreclosures, mortality rates, birth rates, life insurance claims, dividend payments and dividend payment information, U.S. Federal reserve as well as foreign central banks statistics, Gold and/or Silver prices, initial public offerings, initial public offering sectors, investor sentiment ratings and information, money supply information, new corporate listings, NYSE and other exchange programmed trading information, programmed trading information, trading curves, pulse of the economy, SEC and other financial-related filings, and/or registrations and/or registration filings, stock/bond yield gap, stock and/or bond volume, mortgage rates, including fixed and adjustable, prime lending rates, adjustable rate mortgage index, swap rates, BONY ADR indexes, bond buyer municipal bond index, CBOE put/call ratio, Dow Jones Bond average, Dow Jones Global U.S. Index, Dow Jones Industrial Average, S&P 100, S&P 500, emerging markets bond index, Lehman Bros. Corp. Bond index, Lehman Bros. T-Bill index, Russell 2000, Value Line information, Wilshire 5000 index and/or information, Baron's Confidence index, Dow Jones Industrial Average, Dow Jones Transports, Dow Jones Utilities, Dow Jones 65, Dow Jones Global U.S., NYSE Composite, AMEX Composite, S&P Midcap, S&P small cap, Dow Jones advance, decline, unchanged, new high, new low, and daily volume information, Boston Stock Exchange, Chicago Stock Exchange, Philadelphia Stock Exchange, Pacific Stock Exchange, CBOT, CME, CEC, COM, COMX, foreign market and/or foreign market exchange indexes, including, but not limited to, Amsterdam AEX, Athens General, Bangkok SET, Bagota IBB, Bombay Securities, portfolios of securities, mutual funds, trusts, Brussels Bel-20, Benos Aires indices, Caracus indices, Copenhagen indices, Dublin indices, Frankfurt DAX, Helsinki HEX, Hong Kong Hang Seng, Istanbul IKB, Jakarta Composite, Johannesburg Gold, Johannesburg Industrials, Kuala Lumpur Composite, Lisbon indices, London FTSE 100, Madrid General, Manila Composite, Mexico City IPC, Milan indices, Oslo Composite, Paris CAC, Santiago Selective, San Paulo, Seoul Composite, Shanghai Official B, Shenzhen Indices, Singapore indices, Stockholm indices, Sydney indices, Taipei indices, Tel Aviv 100 index Z, Tokyo Nikkei-225, Toronto TSE 300, Vienna ATX, Wellington NZSE-40, Zurich Swiss, Malaysia indices, Mexico indices, Montreal indices, New Zealand indices, Santiago indices, Singapore indices, South Africa indices, South Korea indices, Sri Lanka indices, Stockholm indices, Sydney indices, Taiwan indices, Thailand indices, Tokyo indices, Toronto indices, Vancouver indices, Venezuela indices, Cambridge Associates Index, index futures and options, interest rate futures and options, foreign currency futures and options, commodity indexes, CBOE VIN Index, stock and/or equity futures and options, bond and/or debt futures and options, stock index futures and options, long term equity options, swap futures and options, swaptions, volumes for any of the herein-described futures and options, any and/or all of the Dow Jones, NYSE, AMEX, S&P, NASDAQ, Russell, Value Line, and/or Wilshire indices, any of the various advance/decline volumes and/or advance/decline totals, the daily breadth values for the NYSE and/or for any other exchange, bond indices, volume of bond trading, daily bond values, new offerings, best grade bonds, internal grade bonds, confidence indices, confidence indicators, T-Bill/Euro futures and options, Lehman Bros., T-Bond Index, Lehman Bros. Corporate Bond Index, Ryan labs Treasury Index, Bond Buyer 20 Bond Index, Stock/Bond Yield gaps, Yield on Dow Jones Bond averages, Mortgage related securities, portfolios of securities, mutual funds, trusts, Dow Jones Bonds averages, NYSE Bond averages, Baron's 50 stocks averages, Junk Bond issues, Lehman Bros. Auction Rate Preferred index, Value Line Convertible indices, Advisor Sentiment polls, including Market Vane and Consensus Inc., J.P. Morgan Overseas Govt. Bond Index, J.P. Morgan emerging market Bond index, guaranteed investment contracts, various economic indicators, industrial indicators, agricultural indicators, Federal Reserve data bank factors, monetary base, reserve aggregate, free reserves, money market funds, money supply, adjustable mortgage base rate, money fund report, Federal Reserve key assets and liabilities, money rates, discount rates, federal funds rates, T-Bills, including 13, 26, and 52 weeks, broker call rates, certificates of deposit rates, including all time maturities, certificate of deposit rates, bankers acceptances, LIBOR rates, foreign prime rates, other domestic and/or foreign monetary rates, foreign exchange rates, investor sentiment readings and indicators, gold, silver and other precious metals prices, economic growth and investment indicators and information, production indicators and information, consumption and distribution indicators and information, inventories indictors and information, orders and ordering indicators and information, trade indicators and information, inflation indicators and information, employment indicators and information, unemployment indicators and information, jobless claims indicators and information, construction and new housing starts indicators and information, consumer price index indicators and information, producer price index indicators and information, consumer confidence indicators and information, business failure indicators and information, business starts indicators and information, index of lagging indicators and information, index of leading indicators and information, any and/or all financial and/or investment indicators, federal reserve dollar index, american Debt and Deficit indicators and information, real estate performance indicators and information, dividend payments information, stock split information, security convertibility information, and/or any other information and/or indicators concerning financial and/or financial-related activities, and/or any other indicators, information, indices, etc., regarding any domestic and/or foreign securities, portfolios of securities, mutual funds, trusts, markets, market indices, foreign exchange rates, and/or any stocks, bonds, derivatives, futures, forwards, options, commodities, securities, portfolios of securities, mutual funds, trusts, and/or instruments traded thereon.

The database 10H can also contain any data and/or information regarding any of the herein-described factors, factors ratios, financial markets, market indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, for performing any of the herein-described processing routines and/or for facilitating the operation of the apparatus 100 of the present invention, as described herein.

In any and/or all of the embodiments described herein, certain factors may or may not have quantitative and/or numerical values associated therewith (i.e. the start of a war, the occurrence of a natural disaster, a month of the year, etc.). In these instances, states regarding such factors can be defined by, and/or be assigned, alphanumerical values, numbers, letters, etc., for convenience.

The database 10H also contains data and/or information regarding issuers if securities, portfolios of securities, mutual funds, trusts, such as publicly traded companies, privately held companies, financial intermediaries, banks, and insurance companies. The database 10H can contain price/earnings ratio information, debt/equity ratio information, asset management measures and information, cash coverage ratio information, current ratio information, long-term debt ratio information, long-term solvency measures and information, market to book ratio information, Beta of the security, any technical and/or fundamental measure or ration of the security of the corresponding security issuer or company, market capitalization information, market value measures and information, profitability measures information, quick ratio information, short-term solvency measures and information, book value information, dividend yield information, stock price information compiled by and for any time periods or intervals (i.e. days, hours, minute, seconds), including stock prices tabulations by time of day, time of week, time of month, month of year (i.e. “the January” effect”), time of year, yield percentage information, dividend percentage information, security offerings information, initial public offering information, stock split information, dividend information, including declaration of dividends and dividend payments, debt to equity conversion information, earnings information, earnings reports, earnings estimates information, earned interest ratio and information, total debt ratio and information, bond ratings and ratings information, including ratings by Moody's and Standard & Poors and other rating agencies, borrowing data and/or information, major shareholder data and/or information, executive and/or key employee hiring and/or firings, patents granted, patents acquired, intellectual property granted and/or acquired, mergers, acquisitions, licenses granted, licenses acquired, insider trading activity, insider and/or director, officer, major shareholder, founder, and/or employee sale of stock, including lockout trades and/or trades or sales following public offering activity and/or following prohibited sales periods after public offerings, insider and/or director, officer, major shareholder, founder, and/or employee purchase of stock, and/or any other security-specific and/or company-specific data and/or information which can or may be useful in performing financial analysis, market analysis and/or financial forecasting regarding any of the securities, portfolios of securities, mutual funds, trusts, and/or markets described herein.

The database 10H also contains information regarding any of the security issuers or companies described herein which may be provided by sources internal to the security issuers or companies and/or sources external form the security issuers or companies. The database 10H also contains data and/or information concerning investment portfolios, mutual funds, open ended funds, closed end funds, investment trusts, and/or any other financial investment vehicles (hereinafter collectively referred to as “portfolio”), including beat of the portfolio, return, annual returns, one year average return, three year return, five year return, return form any time period or interval, investment strategy information, investment strategy information changes and/or updates, portfolio component securities, portfolios of securities, mutual funds, trusts, portfolio components, component composition percentages, portfolio managers, investment strategies and/or goals and information relating thereto and/or to changes and/or updates thereto.

The database 10H can also contain weather information, weather forecast information, crop reports, real estate reports, accident information disaster information, natural disaster information, information regarding the occurrence of earthquakes, hurricanes, tornadoes, floods, storms, fires, blizzards, and/or other weather and/or environmental information, travel information, tourism information, insurance claims for insurance policies of any kind including, but not limited to life insurance, health insurance, property insurance, casualty insurance, or disability insurance, etc.

The database 10H can also contain data and/or information regarding any of the financial markets, market indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, described herein.

The database 10H can also contain the values, changes in values, and percentage changes in values, of any of stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and factors which may be found therein, and/or which may be utilized in conjunction with the present invention, with such values, changes in values, and percent changes in values, being ascertained, determined, calculated, and stored, by the central processing computer 10 and/or by the database 10H, for time periods and/or increments before, during, and after, the occurrence of certain events and/or factor changes.

The database 10H can also contain any other data and/or information regarding news events, news reports, or news stories. The database 10H can also contain any other data and/or information regarding advertisements which can be provided by the present invention.

The database 10H can also contain any other data and/or information which may be necessary and/or desirable for performing any of the functions, operations and/or services described herein.

The database 10H can also contain individual investor data and/or information, and/or individual consumer and/or customer information, including personal data and/or information, investment portfolio data and information, investment strategies, investment goals, and/or any other information regarding the individual investor. The database 10H can also contain information regarding the types of securities, portfolios of securities, mutual funds, trusts, which the individual investor is interested in investing in, the factors and/or securities, portfolios of securities, mutual funds, trusts, or other investment opportunities which the individual is interested in respectively being notified about and/or investing in, times of such notification, the occurrence of events and/or other happenings about which the individual investor for desires to be notified, and/or any other data and/or information necessary and/or desired for performing any of the herein-described functions, operations, and/or services.

Any of the data and/or information described as being stored in the database 10H, and/or any of the other databases 20H, 30H, 40H, and/or 50H, can be entered, updated, and/or changed via the central processing computer and/or via any of the individual computer 20, financial institution or financial intermediary computers 30, external information source computers 40, and/or security issuer computers 50. In this regard, for example, an individual can, via the individual computer 20, enter or update information regarding his or her portfolio, a financial institution or financial intermediary can, via the financial institution or financial intermediary computer 30, can, for example, enter information regarding changes to its saving account of certificate of deposit interest rates.

Similarly, for example, an external information source, such as the U.S. Government can, via the external information source computer 40, enter or update information concerning inflation rates, unemployment rates, etc. In a similar manner, a publicly traded company can, via the security issuer computer 50, enter or update its corporate earnings reports of SEC filing information.

The database 10H can include information regarding any financial factor, market, market index, security, bond, commodity information, foreign exchange rate, etc. which is known from, and/or listed in, any financial and/or investing publications, on-line information sources, and/or form any other information source.

Any of the data and/or information described herein can be provided from multiple information sources and/or from multiple entities by utilizing any of the central processing computer 10, individual computers 20, financial institution or financial intermediary computers 30, external information source computers 40, and/or security issuer computers 50.

The database 10H may also contain any other information which may be relevant, pertinent, useful, and/or desired, for facilitating the operation of the apparatus and method of the present invention as described herein and/or as related thereto.

The database 10H, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6^{th} Edition, Prentice Hall 1996.

The database 10H, or collection of databases, may be updated by each of the respective individuals, central processing computer operator or administrator, financial institution or financial intermediary, external information source, and/or the security issuer or company, and/or by any other third party, in real-time, and/or via dynamically linked database management techniques.

The data and/or information stored in the database 10H can also be updated by external sources. The database 10H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2^{nd} Ed., Addison-Wesley Publishing Company, 1994.

The database 10H can also contain information regarding any of the individuals, central processing computer administrators of operators, financial institutions or financial intermediaries, external information sources, and/or the security issuers, described herein.

The contact information can include the central processing computer administrators or operators names, addresses, telephone numbers, fax numbers, e-mails, and/or any other contact information, the individuals names, addresses, telephone numbers, fax numbers, e-mails, and/or any other contact information for the individuals, the financial institutions or financial intermediaries names, addresses, persons to contact, contact individuals, telephone numbers, fax numbers, e-mails, web sites and/or any other contact information for the financial institutions or financial intermediaries, the external information sources names, addresses, persons to contact, contact individuals, telephone numbers, fax numbers, e-mails, web sites, and/or any other contact information for the external information sources, the security issuers names addresses, persons to contact, contact individuals, telephone numbers, fax numbers, e-mails, web sites, and/or any other contact information for the security issuers.

The database 10H can also include any other data and/or information needed and/or desired for facilitating the functions and operation of the present invention as described herein.

With reference once again to FIG. 2, the central processing computer 10 also includes an output device 101 such as a printer, a modem, a fax/modem, or other output device, for providing data and/or information to the operator or user of the central processing computer 10 or to a third party or third party entity.

In the preferred embodiment, each of the central processing computer(s) 10, the individual computer(s) 20, the financial institution or financial information computer(s) 30, the external information source computer(s) 40, and/or the security issuer computer(s) 50, which may be utilized in conjunction with the present invention, can include the same, similar, or analogous, components and/or peripheral devices as described herein for the central processing computer 10. In this manner, any individual computer(s) 20, financial institution or financial information computer(s) 30, external information source computer(s) 40, and/or security issuer computer(s) 50, which may be utilized in conjunction with the present invention, may be the same as, or be similar to, the central processing computer 10.

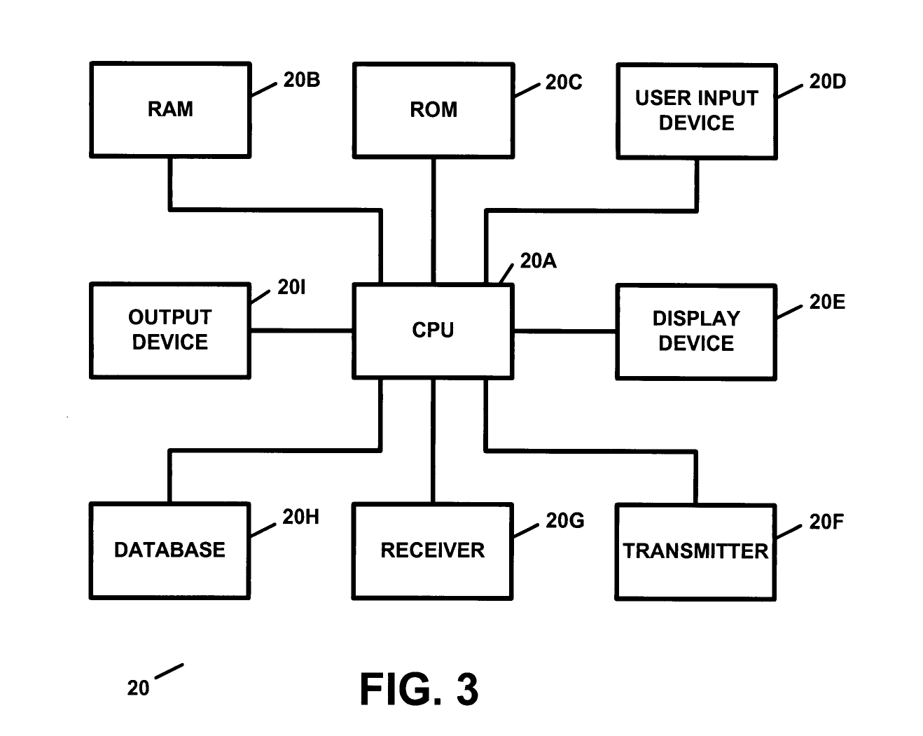

FIG. 3 illustrates the individual computer 20, in block diagram form. The individual computer 20, in the preferred embodiment, is a network computer or computer system which is utilized to access and/or to communicate with any of the computers 10, 20, 30, 40 and/or 50, described herein. In the preferred embodiment, the individual computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The individual computer 20 also includes a random access memory device(s) 20B (RAM) and a read only memory device(s) 20C (ROM), each of which is connected to the CPU 20A, a user input device 20D, for entering data and/or commands into the individual computer 20, which includes any one or more of a keyboard, a scanner, a user pointing device, such as, for example, a mouse, a touch pad, and/or an audio input device and/or a video input device, etc., if desired, which input device(s) is also connected to the CPU 20A. The individual computer 20 also includes a display device 20E for displaying data and/or information to an individual user or operator.

The individual computer 20 also includes a transmitter(s) 20F, for transmitting signals and/or data and/or information to any one or more of the central processing computer(s) 10, individual computer(s) 20, financial institution or financial information computer(s) 30, external information source computer(s) 40, and/or security issuer computer(s) 50, which may be utilized in conjunction with the present invention. The individual computer 20 also includes a receiver 20G, for receiving signals and/or data and/or information from any one or more of the central processing computer(s) 10, individual computer(s) 20, financial institution or financial information computer(s) 30, external information source computer(s) 40, and/or security issuer computer(s) 50, which may be utilized in conjunction with the present invention.

The individual computer 20 also includes a database(s) 20H which can contain any and/or all of the data and/or information described herein with regards to the database 10H of the central processing computer 10 and/or any of the other information regarding or of interest to the individual, the individual's financial accounts, investments, interests, investment habits, and/or any of the information provided by any of the central processing computers 10, the individual computers 20, the financial institution or financial intermediary computers 30, the external information sources computers 40, and/or the security issuers computers 50, and/or any other data and/or information needed and/or desired by the individual.

With reference once again to FIG. 3, the individual computer 20 also includes an output device 201 such as a printer, a modem, a fax/modem, or other output device, for providing data and/or information to the operator or user of the individual computer 20 or to a third party or third party entity.

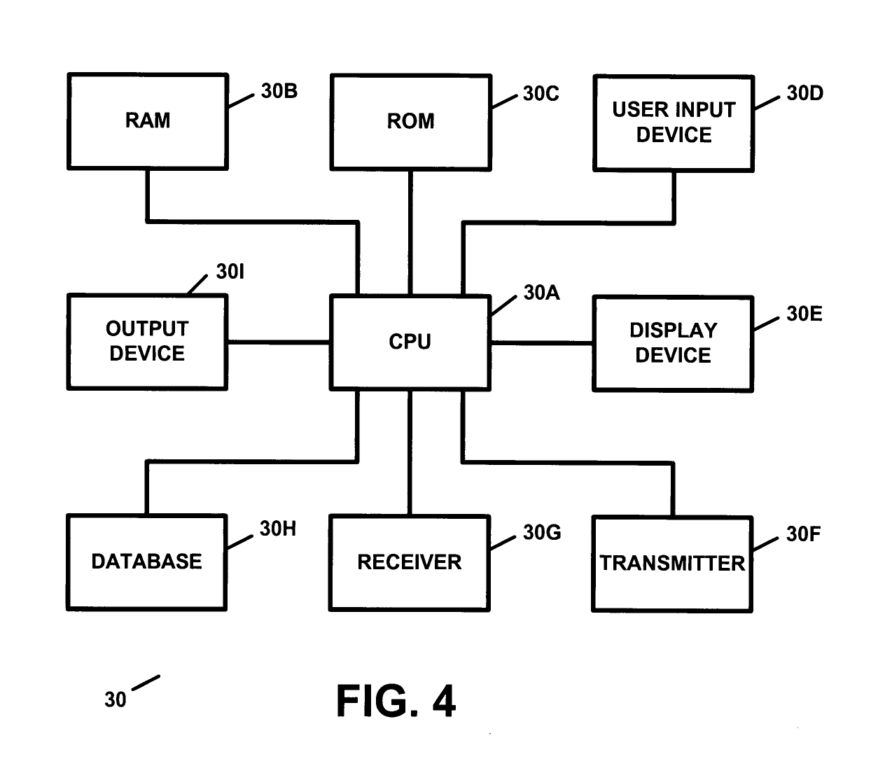

FIG. 4 illustrates the financial institution or financial intermediary computer 30, in block diagram form. The, financial institution or financial intermediary computer 30, in the preferred embodiment, is a network computer or computer system which is utilized to access and/or to communicate with any of the computers 10, 20, 30, 40 and/or 50, described herein. In the preferred embodiment, the financial institution or financial intermediary computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The financial institution or financial intermediary computer 30 also includes a random access memory device(s) 30B (RAM) and a read only memory device(s) 30C (ROM), each of which is connected to the CPU 30A, a user input device 30D, for entering data and/or commands into the financial institution or financial intermediary computer 30, which includes any one or more of a keyboard, a scanner, a user pointing device, such as, for example, a mouse, a touch pad, and/or an audio input device and/or a video input device, etc., if desired, which input device(s) is also connected to the CPU 30A. The individual computer 30 also includes a display device 30E for displaying data and/or information to an individual user or operator.

The financial institution or financial intermediary computer 30 also includes a transmitter(s) 30F, for transmitting signals and/or data and/or information to any one or more of the central processing computer(s) 10, individual computer(s) 20, financial institution or financial information computer(s) 30, external information source computer(s) 40, and/or security issuer computer(s) 50, which may be utilized in conjunction with the present invention.

The financial institution or financial intermediary computer 30 also includes a receiver 30G, for receiving signals and/or data and/or information from any one or more of the central processing computer(s) 10, individual computer(s) 20, financial institution or financial information computer(s) 30, external information source computer(s) 40, and/or security issuer computer(s) 50, which may be utilized in conjunction with the present invention.

The financial institution or financial intermediary computer 30 also includes a database(s) 30H which can contain any and/or all of the data and/or information described herein with regards to the database 10H of the central processing computer 10 and/or any of the other information regarding or of interest to the financial institution or financial intermediary, the financial institution's or financial intermediary's financial accounts, investments, interests, investment habits, and/or any of the information provided by any of the central processing computers 10, the individual computers 20 financial institution or financial intermediary computers 30, the external information sources computers 40, and/or the security issuers computers 50, and/or any other data and/or information needed and/or desired by the financial institution or financial intermediary, and/or any and/or all information stored in any of the databases described herein.

With reference once again to FIG. 4, the financial institution or financial intermediary computer 30 also includes an output device 301 such as a printer, a modem, a fax/modem, or other output device, for providing data and/or information to the operator or user of the individual computer 20 or to a third party or third party entity.

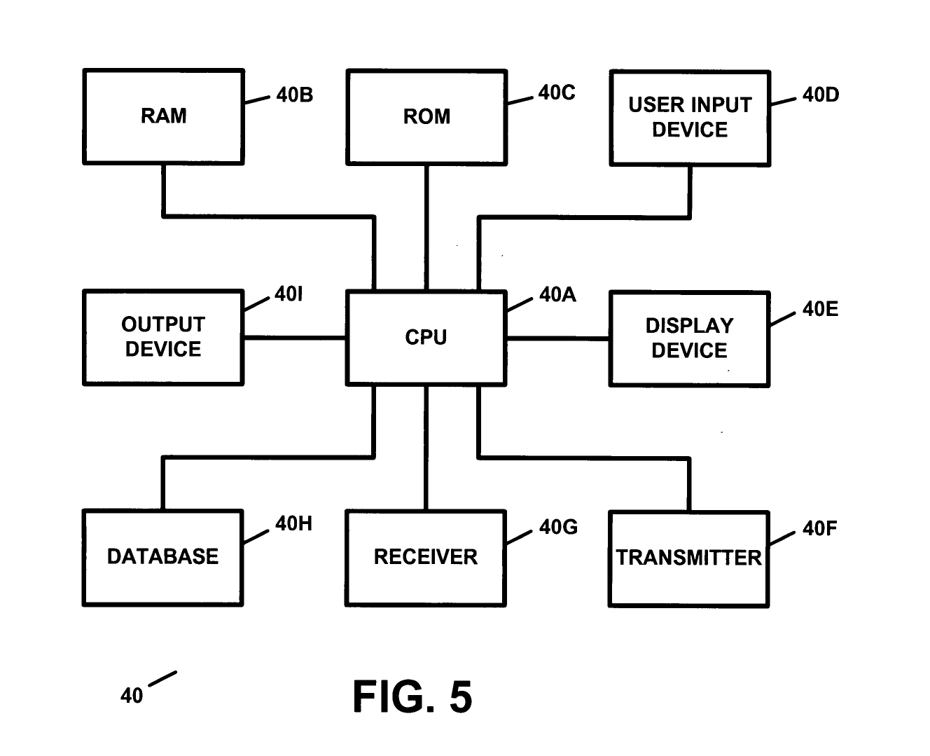

FIG. 5 illustrates the external information source computer 40, in block diagram form. The external information source computer 40, in the preferred embodiment, is a network computer or computer system which is utilized to access and/or to communicate with any of the computers 10, 20, 30, 40 and/or 50, described herein. In the preferred embodiment, the external information source computer 40 includes a central processing unit or CPU 40A, which in the preferred embodiment, is a microprocessor. The CPU 40A may also be a microcomputer, a minicomputer, a macro-computer, and/or a mainframe computer, depending upon the application.

The external information source computer 40 also includes a random access memory device(s) 40B (RAM) and a read only memory device(s) 40C (ROM), each of which is connected to the CPU 40A, a user input device 40D, for entering data and/or commands into the external information source computer 40, which includes any one or more of a keyboard, a scanner, a user pointing device, such as, for example, a mouse, a touch pad, and/or an audio input device and/or a video input device, etc., if desired, which input device(s) is also connected to the CPU 40A. The external information source computer 40 also includes a display device 40E for displaying data and/or information to a individual user or operator.

The external information source computer 40 also includes a transmitter(s) 40F, for transmitting signals and/or data and/or information to any one or more of the central processing computer(s) 10, individual computer(s) 20, financial institution or financial information computer(s) 30, external information source computer(s) 40, and/or security issuer computer(s) 50, which may be utilized in conjunction with the present invention. The external information source computer 40, also includes a receiver 40G, for receiving signals and/or data and/or information from any one or more of the central processing computer(s) 10, individual computer(s) 20, financial institution or financial information computer(s) 30, external information source computer(s) 40, and/or security issuer computer(s) 50, which may be utilized in conjunction with the present invention.

The external information source computer 40, also includes a database(s) 40H which can contain any and/or all of the data and/or information described herein with regards to the database 10H of the central processing computer 10 and/or any of the other information regarding or of interest to the external information source, the external information source's sources of information, the external information source's financial accounts, investments, interests, investment habits, and/or any of the information provided by any of the central processing computers 10, the individual computers 20, financial institution or financial intermediary computers 30, the external information sources computers 40, and/or the security issuers computers 50, and/or any other data and/or information needed and/or desired by the external information source, and/or any and/or all information stored in any of the databases described herein.

With reference once again to FIG. 5, the external information source computer 40 also includes an output device 401 such as a printer, a modem, a fax/modem, or other output device, for providing data and/or information to the operator or user of the external information source computer 40 or to a third party or third party entity.

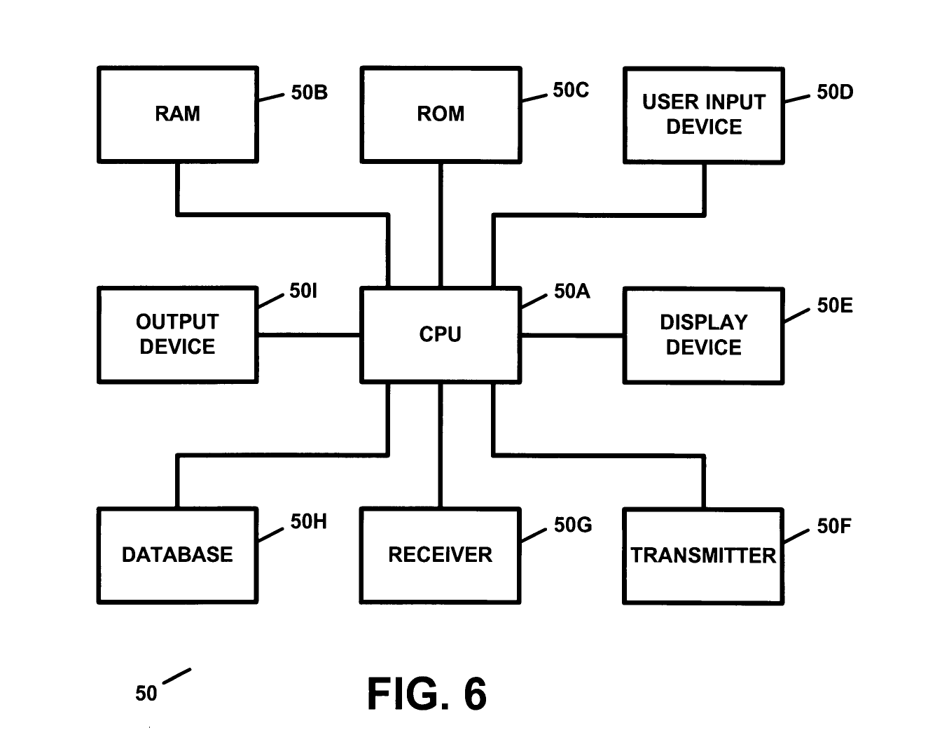

FIG. 6 illustrates the security issuer computer 50, in block diagram form. The external security issuer computer 50, in the preferred embodiment, is a network computer or computer system which is utilized to access and/or to communicate with any of the computers 10, 20, 30, 40 and/or 50, described herein. In the preferred embodiment, the security issuer computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The security issuer computer 50 also includes a random access memory device(s) 50B (RAM) and a read only memory device(s) 50C (ROM), each of which is connected to the CPU 50A, a user input device 50D, for entering data and/or commands into the security issuer computer 50, which includes any one or more of a keyboard, a scanner, a user pointing device, such as, for example, a mouse, a touch pad, and/or an audio input device and/or a video input device, etc., if desired, which input device(s) is also connected to the CPU 50A. The security issuer computer 50 also includes a display device 50E for displaying data and/or information to an individual user or operator.

The security issuer computer 50 also includes a transmitter(s) 50F, for transmitting signals and/or data and/or information to any one or more of the central processing computer(s) 10, individual computer(s) 20, financial institution or financial information computer(s) 30, external information source computer(s) 40, and/or security issuer computer(s) 50, which may be utilized in conjunction with the present invention. The security issuer computer 50, also includes a receiver 50G, for receiving signals and/or data and/or information from any one or more of the central processing computer(s) 10, individual computer(s) 20, financial institution or financial information computer(s) 30, external information source computer(s) 40, and/or security issuer computer(s) 50, which may be utilized in conjunction with the present invention.

The security issuer computer 50 also includes a database(s) 50H which can contain any and/or all of the data and/or information described herein with regards to the database 10H of the central processing computer 10 and/or any of the other information regarding or of interest to the security issuer, the security issuers records, sources of information, the security issuer's financial ratings, financial status, operation status, operational information, personnel information, financial accounts, investments, interests, investment habits, and/or any of the information provided by any of the central processing computers 10, the individual computers 20, financial institution or financial intermediary computers 30, the external information sources computers 40, and/or the security issuers computers 50, and/or any other data and/or information needed and/or desired by the security issuer, and/or any and/or all information stored in any of the databases described herein.

With reference once again to FIG. 6, the security issuer computer 50 also includes an output device 501 such as a printer, a modem, a fax/modem, or other output device, for providing data and/or information to the operator or user of the security issuer computer 50 or to a third party or third party entity.

The databases 20H, 30H, 40H, and/or 50H, can contain any and/or all of the data and/or information which is stored and/or contained in the database 10H. In the same manner, any of the data and/or information which is stored in the databases 20H, 30H, 40H, and/or 50H, can be stored in the database 10H.

The database 10H, or collection of databases which form the database 10H, as well as any database 20H, 30H, 40H. and/or 50H, described herein, can be implemented by utilizing database software and/or spreadsheet software, such as, for example database software by Oracle®, Microsoft® Access® and/or Microsoft® Excel®, or any other suitable database or spreadsheet software programs and/or systems.

The data and/or information which is stored in the database 10H, 20H, 30H, 40H, and/or 50H, can be linked via any suitable data linking techniques such as, for example, dynamically linked lists (DLLs), linked lists, and object links embedded (OLE's).

The data and/or information which is store in the database 10H can be entered and/or updates manually by an operator, automatically by a communication link from the respective information sources, and/or via links, communication links, and/or dynamically linked lists, to, and/or with, any of the other databases 10H, 20H, 30H, 40H, and/or 50H, and/or any other external information source. Any of the data and/or information stored in any of the databases 10H, 20H, 30H, 40H, and/or 50H, and/or any other external information source, utilized in the present invention, can be updated at specified time intervals, at certain times, times of day, days, days of week, daily, weekly, bi-weekly, monthly, quarterly, semi-annually, annually, and/or at any of the time interval or period, upon the occurrence of certain events, upon the occurrence of a factor, a security, a security factor, and/or upon the occurrence of any pre-specified event or activity.

Any of the databases 10H, 20H, 30H, 40H, and/or 50H, described herein, can include multiple databases, databases on different computers, and/or databases on computers which are external from their respective resident computers.

Any of the computers 10, 20, 30, 40, and/or 50, described herein, can include a multiple computers and/or computer systems.

Any of the databases 101H, 20H, 30H, 40H, and/or 50H, described herein, in the preferred embodiment, will contain statistical data and/or information concerning any of the data and/or information stored in said databases. The statistical data and/or information can be utilized to perform historical analyses, present analyses, future predictions, and/or forecasting, as well as providing any data and/or information which can be utilized by the present invention in performing any of the operations described herein.

The data and/or information regarding all of the financial markets, market indices, stocks, bonds, securities, equity instruments, bond instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, hereinafter referred to collectively as “securities”, and the factors, financial factors and factor models, hereinafter referred to collectively as “factors”, described herein, are stored in the database 10H, and in of the other databases 20H, 30H, 40H, and/or 50H, described herein, can be stored, in the preferred embodiment, in a variety of manners.

The values for the financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, factors, changes in the values of the respective financial markets, market indices, stocks, bonds, securities, equity instruments, debt instruments, portfolios of securities, mutual funds, trusts, currencies, commodities, foreign exchange rates, interest rates, currencies, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and factors, can be ascertained, determined, calculated, whichever the case may be, and stored, at pre-defined time intervals which can be any appropriate time interval, such as, but not limited to, time intervals in seconds, fractions of seconds, minutes, hours, days months, years, etc. The central processing computer 10 can be programmed to ascertain, determine, calculate, whichever the case may be, and store, any of the herein described values.

The values, change in values, and percentage change in values, of the financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and factors can also be ascertained, determined, calculated, whichever the case may be, and stored, upon the occurrence of certain events, which may or not be pre-defined events, such as, for example, an issuance of a inflation report. The central processing computer 10 can be programmed to ascertain, determine, calculate, whichever the case may be, and store, any of the herein described values upon the occurrence of the event.

The values, changes in values, and percentage changes in values, of any of the financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and factors, which may be utilized in conjunction with the present can be ascertained, determined, calculated, and stored, for time periods and/or increments before, during, and after, the occurrence of certain events and/or factor changes.

The values, change in values, and percentage change in values, of the financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and factors, can also be ascertained, determined, calculated, whichever the case may be, and stored, upon the occurrence of a change in any financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and/or any factor or factors, which financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and/or factors may or may not be pre-defined events, such as, for example, a change in a price of a stock in a company, and/or a change on a factor such as a benchmark interest rate.

The central processing computer 10 can be programmed to ascertain, determine, calculate, whichever the case may be, and store, any of the herein described values upon the occurrence of a change in any financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and/or any factor or factors.

The database 10H, as well as any of the other databases described herein, in the preferred embodiment, can also contain correlation ratios, values and/or relationships for any two or more of the financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and factors described herein.

In this regard, a correlation ratio can be calculated for any two factors of interest in order to determine a relationship between them. This ratio will correspond to a given change in value for a security. In this manner, for example, a new factor, the ratio of the factors or “ratio factor”, is created which can be correlated, for example, to a change in a security's value. For example, ratio factors can be calculated for any two or more security values, change in values, percent change in values, factor values, change in factor values, percent change in factor values, and/or any other data and/or information utilized in conjunction with the present invention.

Some of the ratio factors which can be calculate include, but are not limited to, a ratio of a factor value, change in value, or percent change in value, to another factor value, change in value, or percent change in value; a ratio of a security value, change in value, or percent change in value, to another security value, change in value, or percent change in value; a ratio of a security value, change in value, or percent change in value, to a factor value, change in value, or percent change in value; a ratio of a factor value, change in value, or percent change in value, to a security value, change in value, or percent change in value; a ratio of any factor and/or factor ratio to any other factor and/or factor ratio; a ratio of any security and/or factor ratio to any other factor and/or factor ratio; a ratio of any factor and/or factor ratio to a security and/or factor ratio; a ratio of any security and/or factor ratio to any other security and/or factor ratio, and so on.

Any ratio may be calculated for any of the security data and/or information and factor data and/or information which is utilized in conjunction with the present invention. Factor ratios can be calculated and utilized for any factor, security, or factor ratio, with any other factor, security, or factor ratio. Factor ratios of factor ratios can also be calculated and utilized.

Specific financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, factors and/or factor ratios, or any combination(s) of same, can be selected by any individual for use in conjunction with his or her own account.

These individually selected financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, factors and/or factor ratios can be stored in the database 10H, as well as in the database 20H in the individual's individual computer 20, as well as in any other database described herein.

Historical data and/or information for any and all of the data and/or information described herein, will also be stored in the database 10H and/or in any of the other databases described herein. In this manner, various mathematical analyses can be performed by the central processing computer 10 in order to provide any information, historical activity, trends, forecasts, etc., which is described herein as being provided by the present invention.

The data and/or information which is stored in the database 10H will also include statistical data and/or information, probabilistic data and/or information, and any other data and/or information needed and/or desired for carrying out the present invention. Forecast data and/or information can also be stored in the database 10H as well as any of the other databases described herein.

The database 10H may contain any number of database, relational databases, and/or other databases. The database 10H, as well as any of the other databases 20H, 30H, 40H, and/or 50H, can also include and/or contain spreadsheets for storing any data and/or information described herein as well as for performing various calculations needed for utilizing the apparatus 100, any of the computers 10, 20, 30, 40, and/or 50, and/or any of the components thereof.

The present invention can be utilized in a number of preferred embodiments, in order to provide financial information and/or investment information, and/or information regarding any of the financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, described herein.

The present invention can also be utilized so as to obtain information regarding factors and/or changes in factors and how this information can provide useful financial and/or investment information. The present invention can also be utilized so as to provide historical data and/or information regarding how financial markets, market indices, stocks, bonds, securities, equity instruments, debt instruments, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, and/or portfolios have been affected by factors and/or changes in factors, as well as for providing forecasts of future security and/or portfolio behavior and/or value and/or price movement and/or fluctuation.

The present invention can also be utilized in order to ascertain a current status of a market, index, stock, bond, security, portfolio of securities, mutual fund, trust, currency, commodity, foreign exchange rate, interest rate, a real estate investment trust, real estate, a real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, and/or to investigate, to check on, and/or to research, a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, and to ascertain historical information regarding if, or how, the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, has and/or could be affected by a factor, by a change in a factor, by a factor ratio, and/or by a change in a factor ratio.

The present invention can also be utilized to obtain information regarding a factor and any correlation, and/or effect, which that factor may have with, and/or on, a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, the behavior of the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, and/or any value and/or price movement and/or fluctuation in the market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, which may be correlated with the factor(s).

The present invention can also be utilized so as to provide notification to an individual of a change or changes in a factor or factors as well as providing information concerning a market, index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, and/or any portfolio(s) which may be correlated with the factor or factors, with any changes in the respective factor or factors, historical information regarding any correlation between the financial market, market index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product, and/or forecasts of behavior and/or value and/or price movement and/or fluctuation in, and/or regarding, the financial market, market index, stock, bond, security, portfolio of securities, mutual fund, trust, currency, commodity, foreign exchange rate, interest rate, real estate investment trust, real estate, real property, utility service, utility product, energy service, energy product, telecommunication service, telecommunication product, debt product, credit product, credit derivative product, derivative, option, future, forward, and/or other contract associated therewith and/or related thereto, and/or any and/or other financial instrument or related instrument or product.

The present invention can also be utilized to provide notification of or regarding a news event, a news report, or a news story.

The present invention can also be utilized to provide and advertisement or advertisements.

The present invention can also be utilized in order to provide protection and/or investment protection for a financial account, a brokerage account, a commodities account, an on-line brokerage account, a consumer account, and/or an investment account or portfolio. This can be accomplished by ascertaining a change or changes in a factor or factors which can be correlated with the financial markets, market indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, in the respective a financial account, a brokerage account, a commodities account, an on-line brokerage account, a consumer account, and/or an investment account or portfolio, calculating possible affects of the change in the factor or factors, and providing notification of the change in the factor of factors, as well as the forecasted and/or possible affects on the a financial account, a brokerage account, a commodities account, an on-line brokerage account, a consumer account, and/or an investment account or portfolio, which may be correlated with the change in the factor or factors.

The present invention can also be utilized in order to take action on behalf of the individual or account holder, such as by purchasing, buying, selling, trading, borrowing, exchanging, obtaining a position in, and/or liquidating a position in, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trusts, real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), for, or on behalf of, the individual and/or in the individual's account, in response to a change in a factor, factors, or a factor ratio(s).

In any and/or all of the embodiments described herein, any of the operations, tasks and/or functions described herein can be implemented and/or executed by intelligent agents, software agents, and/or mobile agents. In this regard, the present invention can provide for an agent-based apparatus and method for providing financial information, investment information, and/or other information.

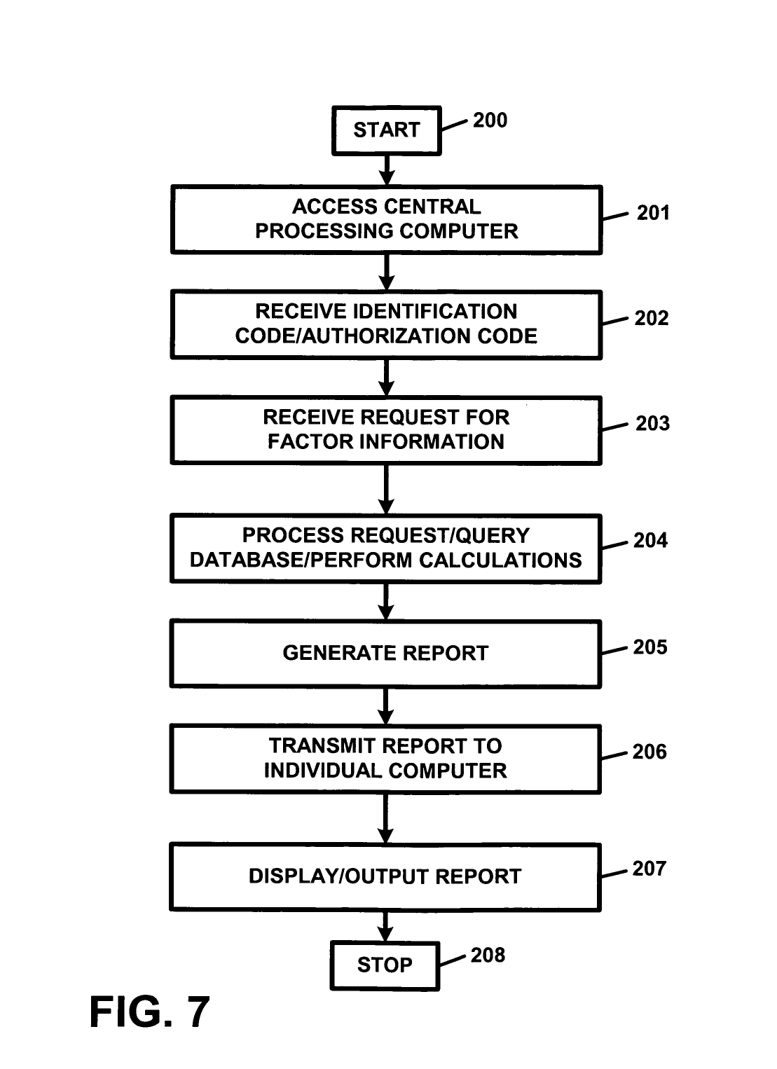

FIG. 7 illustrates a preferred embodiment operation of the apparatus 100 in flow diagram form. In the preferred embodiment illustrated by FIG. 7, the apparatus 100 of the present invention can be utilized so as to provide information regarding state(s) of, and/or changes in, a factor, factors, factor ratios, and/or any financial markets, market indices, stocks, bonds, securities, portfolios of securities, mutual funds, trusts, currencies, commodities, foreign exchange rates, interest rates, currencies, real estate investment trusts, real estate, real property or real properties, utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments, which can serve as a factor or factors, factors which can serve as factors, and/or their respective values along with data and/or information regarding a stock(s), bond(s), security or securities, portfolio(s) of securities, financial market(s), market index or indices, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which can be correlated thereto.

The present invention can then provide data and/or information regarding information regarding a stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), such as, but not limited to, information regarding historical correlation with certain factors of interest and/or statistical information and/or forecasts for future fluctuations, movements, valuations and/or price changes or movements regarding same.

The operation of the apparatus commences at step 200. At step 201, an individual can access the central processing computer 10 via the individual computer 20 associated with the individual. In any and/or all of the embodiments described herein, the individual computer 20 can also take the form of a kiosk or terminal which is located at a pubic place or location. At step 202, the individual can enter a personal identifier and/or authorization code, if required for security purposes, which is received by the central processing 10.

At step 203, the individual can enter a request to receive information regarding the state(s) of any of the factors, factor ratios, and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, any factors which serves as factors, a single factor, a single factor ratio, and/or a single factor which serves as a factor, described herein, the value(s) of any of the factors, factor ratios, and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, described herein, the change in value of any of the factors, factor ratios, and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, described herein, and/or the percent change in any of the factors, factor ratios, and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, described herein.

The individual can also request information concerning any factors, factor ratios, and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, which have recently changed and/or been updated and/or modified. This request will also be received by the central processing computer 10 at step 203.

At step 203, the individual may also request to receive information regarding any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which may have a correlation of any kind, positive, negative, or no correlation, with any of the factors, factor ratios, and/or any and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, which have been requested and/or which may be identified as a result of any search and/or query performed pursuant to the request made at step 203. At step 203, historical data and/or information and/or statistical information and/or forecasting information regarding any of the and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration may also be requested.

At step 203, the individual can also enter a request to receive information regarding a news event, a news report, or a news story, or the plural of same. At step 203, the individual can also enter a request to receive information regarding an advertisement or advertisements regarding a good, a product, or a service, or the plural of same.

At step 204, the central processing computer 10 will process the request made at step 203 and perform a search and/or database query of the database 10H in conjunction with any and/or all of the factors data and/or information, the factor ratios data and/or information, data and/or information regarding any of and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or data and/or information regarding factors which serve as factors, and/or the and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration and/or commodities under consideration.

At step 204, the central processing computer 10 will perform all necessary searches and calculations needed in order to provide the requested factor and/or factor model information, and to provide the requested and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), information including any historical correlational information regarding the respective and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and any of the factors, factor ratios, and/or any and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, and/or the and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration.

At step 204, the central processing computer 10 will also, perform any requested statistical and/or forecasting calculations and/or analyses in order to provide forecasts for the respective and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), as these forecasts may relate to the factor and/or factor ratio information and/or as the forecast may relate to any other information.

The central processing computer 10 will thereafter, at step 205, generate a report in response to the individual's request at step 203.

The report can contain a list of factors and/or factor models, which were either specifically requested and/or identified, and/or which were identified as being responsive to the request and/or which were identified as having been recently changed and/or updated and/or modified. The report can also contain information regarding the state(s), value(s), changes in value(s), and/or percent changes in value(s), of the factors, factor ratios, and/or any and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, commodities which serve as factors, factors which serve as factors, and/or information regarding any and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which were either requested and/or identified as a result of the request at step 203 and/or identified as a result of the processing at step 204.

The report can also contain historical data and/or information concerning any correlation between the and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and any factor(s), factor ratio(s), and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), contained therein, as well as past behavior of the and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The report can also contain statistical predictions and/or forecasts regarding future behavior, price movements, and/or valuation, of the and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), contained in the report.

The report may also contain information regarding a news event, a news report, or a news story, or the plural of same, which may or may not have been requested by the individual. The report may also contain information regarding an advertisement or advertisements regarding a good, a product, or a service, or the plural of same.

At step 206, the report will be transmitted from the central processing computer 10 to the individual computer 20. At step 207, the report can be viewed by the individual via the display device 20E and/or be output from the output device 201, such as by being printed from a printer. While described as being transmitted to the individual computer 20 and being viewed and/or output via the respective display device 20E and/or output device 20I, the report may, in addition and/or in the alternative, be transmitted to the individual via electronic transmission, e-mail transmission, facsimile transmission, telephone message, telephone call, physical mail delivery, and/or via any other suitable communication technique, medium, or method. Thereafter, the operation of the apparatus 100 will cease at step 208.

In any and/or all of the embodiments described herein, any of the data and/or information described as being requested, and/or obtained, via, and/or at, the individual computer 20 can also be requested and/or obtained, via, and/or at, any of the other computers 30, 40, and/or 50, described herein.

In any and/or all of the embodiments described herein, the individual may utilize more than one individual computer and/or more than one type of individual computer. In this regard, the individual may enter his or her request on one individual computer and receive the report on a different individual computer and/or a different computer type.

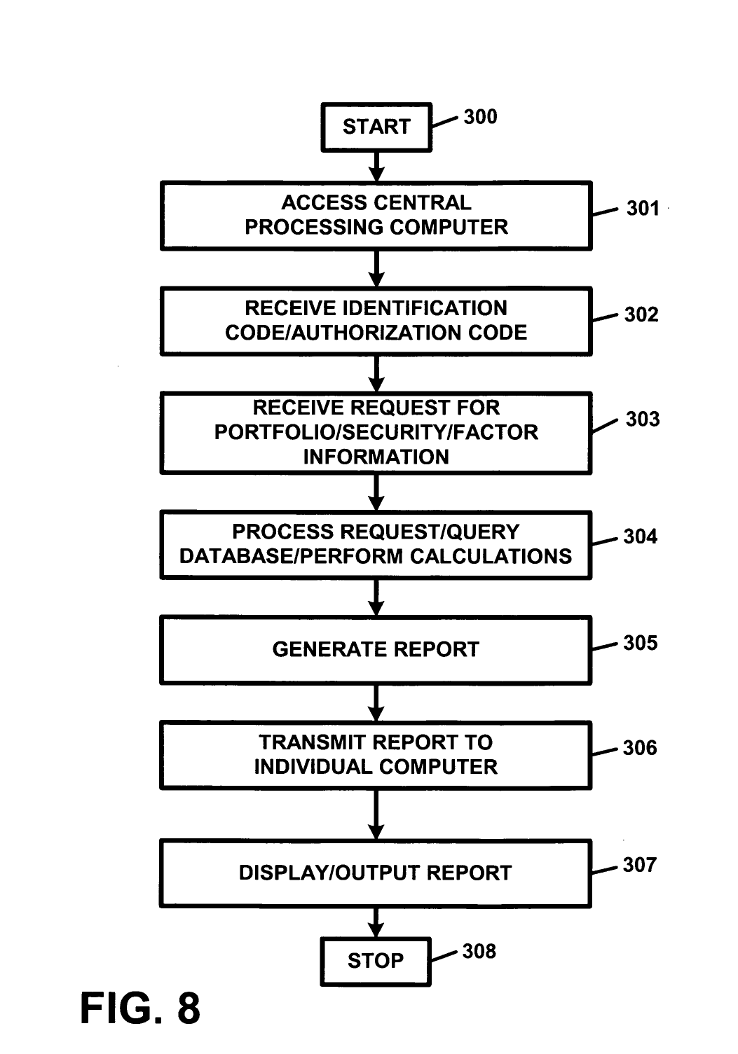

FIG. 8 illustrates another preferred embodiment operation of the apparatus 100 in flow diagram form. In the preferred embodiment illustrated by FIG. 8, the apparatus 100 of the present invention can be utilized so as to provide information regarding any a stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), in response to a state(s) of, and/or changes in, factors, factor ratios, and/or any stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which can serve as factors, and/or factors which can serve as factors, and/or their respective values along with data and/or information regarding how, and to what extant, the stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), may be correlated therewith.

In this manner, an individual may ascertain how a change in a state(s) of a factor and/or a factor ratio, and/or other stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), may affect his or her respective account or portfolio.

The present invention can then provide data and/or information regarding the individual's account or portfolio, or stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), including, but not limited to, historical correlation, statistical information, and/or forecasts for future fluctuations, movements, valuations and/or price changes, or movements in the account(s), portfolio(s), stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), with certain factors or factor ratios of interest.

The preferred embodiment of FIG. 8 is described as being utilized in conjunction with ascertaining and/or processing information regarding an investment portfolio or security.

While described as being utilized in conjunction with ascertaining and/or processing information regarding an investment portfolio or security, the apparatus and method of the present invention can also be utilized in a same, a similar, and/or in an analogous, manner in order to ascertain and/or processing information regarding any of the herein-described account(s), portfolio(s), stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The operation of the apparatus commences at step 300. At step 301, an individual can access the central processing computer 10 via the individual computer 20 associated with the individual. In any and/or all of the embodiments described herein, the individual computer 20 can also take the form of a kiosk or terminal which is located at a pubic place or location.

At step 302, the individual can enter a personal identifier and/or authorization code, if required for security purposes, which is received by the central processing 10. At step 302, the individual can identify the investment portfolio or the security which is to be the subject of the inquiry. The investment portfolio or security information may be stored in the database 10H or the information may be entered by the individual at step 302.

At step 303, the individual can enter a request to receive information regarding the identity, state(s), values(s), changes in value(s), and/or percent changes in value(s), of and for any of the factors, factor ratios, stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, described herein, which may be correlated with the subject investment portfolio or security. The individual can also request information concerning any factors, factor ratios, stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, which have recently changed and/or been updated and/or modified. This request will also be received by the central processing computer 10 at step 303.

At step 303, historical data and/or information and/or statistical information and/or forecasting information regarding any of the portfolio(s), investment portfolio(s), security, and/or securities, under consideration may also be requested.

At step 303, the individual may also request to receive information regarding any stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which may have a correlation of any kind, positive, negative, or no correlation, with any of the factors, factor ratios, stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, commodities which serve as factors, and/or factors which serve as factors, which have been requested and/or which may be identified as a result of any search and/or query performed pursuant to the request made at step 303.

At step 303, the individual can also enter a request to receive information regarding a news event, a news report, or a news story, or the plural of same. At step 303, the individual can also enter a request to receive information regarding an advertisement or advertisements regarding a good, a product, or a service, or the plural of same.

At step 304, the central processing computer 10 will process the request made at step 303 and perform a search and/or database query of the database 10H in conjunction with any and/or all of the factors data and/or information, the factor ratios data and/or information, and/or with data and/or information regarding any of the stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, any of the factors which serve as factors, and/or the portfolio(s), investment portfolio(s), security, and/or securities, under consideration.

At step 304, the central processing computer 10 will perform all necessary searches and calculations needed in order to provide the requested information regarding the investment portfolio or security, including, but not limited to, any requested historical correlational information regarding any respective portfolio(s), investment portfolio(s), security, and/or securities, in the investment portfolio, and/or any commodity and/or commodities in the investment portfolio, and for the investment portfolio as a whole, or the security, commodity, and any of the factors, factor ratios, stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, and/or the portfolio(s), investment portfolio(s), security, and/or securities, under consideration.

At step 304, the central processing computer 10 will also perform any requested statistical and/or forecasting calculations and/or analyses in order to provide forecasts for the portfolio(s), investment portfolio(s), security, and/or securities, in the investment portfolio, for the commodity or commodities in the investment portfolio, and for the investment portfolio as a whole, as these forecasts may relate to the factor and/or factor ratio and/or investment portfolio or security information and/or as the forecast may relate to any other information. The central processing computer 10 will thereafter, at step 305, generate a report in response to the individual's request at step 303.

The report can contain a list of factors and/or factor models, which were identified as being correlated with the portfolio(s), investment portfolio(s), security, and/or securities, comprising same, and/or which were identified as being responsive to the request and/or which were identified as having been recently changed and/or updated and/or modified. The report can also contain information regarding the state(s), value(s), changes in value(s), and/or percent changes in value(s), of the factors, factor ratios, stock(s), bond(s), security or securities, portfolio(s) of securities, an investment portfolio(s), a commodities portfolio(s), market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, and/or information regarding the investment portfolio, the security, commodity, securities, commodities, portfolios of securities, portfolio of commodities, mutual funds, trusts, and/or real estate investment trust(s), comprising same, which may have been either requested and/or identified as a result of the request at step 303 and/or identified as a result of the processing at step 304.

The report can also contain historical data and/or information concerning any correlation between the investment portfolio, security, securities, commodity, commodities, and any portfolios of securities, portfolios of commodities, mutual funds, trusts, contained therein, as well as past behavior of the investment portfolio or the security, securities, commodity, commodities, and any portfolios of securities, portfolios of commodities, mutual funds, trusts, contained therein.

The report can also contain statistical predictions and/or forecasts regarding future behavior, price movements, and/or valuation, of the investment portfolio, the security, or any security, securities, commodity, commodities, and any portfolios of securities, portfolios of commodities, mutual funds, trusts, contained therein.

The report may also contain information regarding a news event, a news report, or a news story, or the plural of same, which may or may not have been requested by the individual. The report may also contain information regarding an advertisement or advertisements regarding a good, a product, or a service, or the plural of same.

At step 306, the report will be transmitted from the central processing computer 10 to the individual computer 20. At step 307, the report can be viewed by the individual via the display device 20E and/or be output from the output device 201, such as by being printed from a printer. While described as being transmitted to the individual computer 20 and being viewed and/or output via the respective display device 20E and/or output device 201, the report may, in addition and/or in the alternative, be transmitted to the individual via electronic transmission, e-mail transmission, facsimile transmission, telephone message, telephone call, physical mail delivery, and/or via any other suitable communication technique, medium, or method. Thereafter, the operation of the apparatus 100 will cease at step 308.

As noted above, the above-described embodiment of FIG. 8 can be utilized in order to ascertain and/or process information regarding any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), described herein.

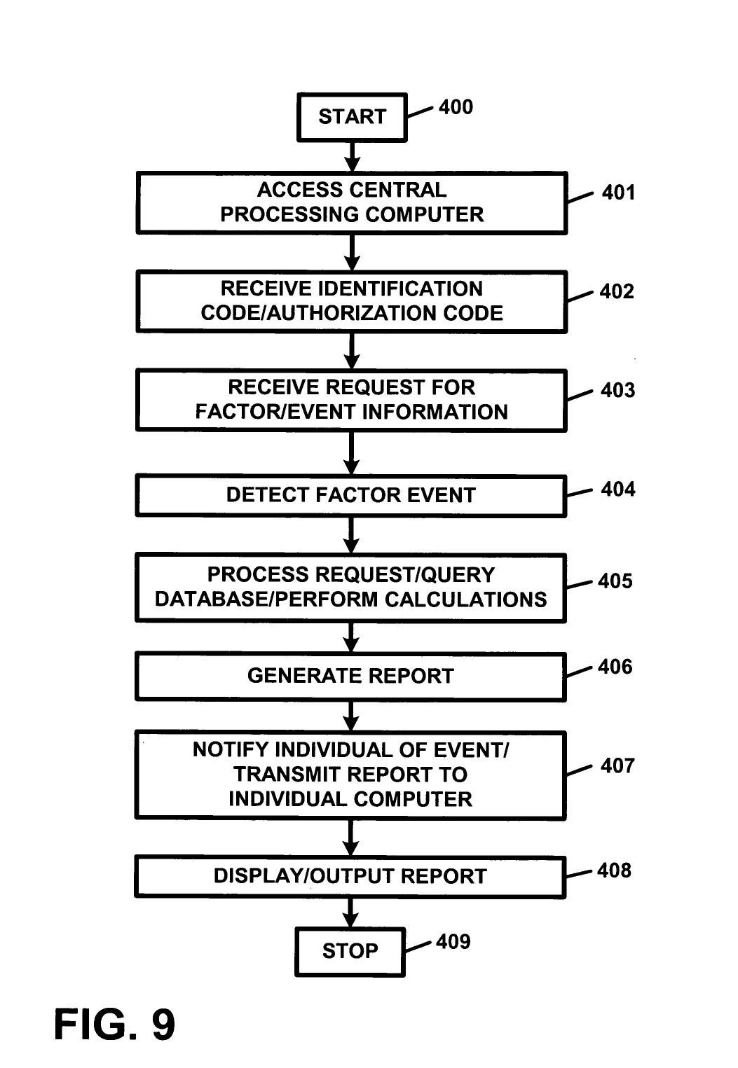

FIG. 9 illustrates a preferred embodiment operation of the apparatus 100 in flow diagram form. In the preferred embodiment illustrated by FIG. 9, the apparatus 100 of the present invention can be utilized so as to provide notification to an individual of changes in a factor or factors as well as providing information concerning a stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and/or any of the factors and/or financial and/or other factors described herein, which may be correlated with the factor or factors.

The apparatus 100 can also provide information regarding any changes in the respective factor or factors, historical information regarding any correlation between the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and/or forecasts of behavior and/or value and/or price movement and/or fluctuation in, and/or regarding, the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The operation of the apparatus commences at step 400. At step 401, the individual can access the central processing computer 10 via the individual computer 20 associated with the individual. In any and/or all of the embodiments described herein, the individual computer 20 can also take the form of a kiosk or terminal which is located at a pubic place or location. At step 402, the individual can enter a personal identifier and/or authorization code, if required for security purposes, which is received by the central processing 10.

At step 403, the individual can enter a request to be notified upon the occurrence of an event, a state of, a change in state of, a change in value of, and/or a percent change in value of, and/or for, any of the factors, factor ratios, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, any factors which serve as factors, a single factor, and/or a single factor ratio, described herein.

The individual can also, at step 403, request to receive any of the information described herein as being provided by the present invention, such as, for example, how the respective occurrence, state, change in state, change in value, and/or percent change in value, can or may effect any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), of interest to the individual. This request will also be received by the central processing computer 10 at step 403.

At step 403, the individual may also request to receive information regarding any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which may have a correlation of any kind, positive, negative, or no correlation, with any of the factors, factor ratios, stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, commodities which serve as factors, and/or factors which serve as factors, which have been requested and/or which may be identified as a result of any search and/or query performed pursuant to the request made at step 403.

At step 403, historical data and/or information and/or statistical information and/or forecasting information regarding any of the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration may also be requested.

At step 403, the individual can also enter a request to receive information regarding a news event, a news report, or a news story, or the plural of same. At step 403, the individual can also enter a request to receive information regarding an advertisement or advertisements regarding a good, a product, or a service, or the plural of same.

At step 404, the central processing computer 10 detects the occurrence of, the state of, the change in state of, the change in value of, and/or the percent change in value of, the factor(s), factor ratio(s), stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or a factor or factors which serve as factors, which were specified by the individual at step 403.

At step 405, the central processing computer 10 will process the request made at step 403 and perform a search and/or database query of the database 10H in conjunction with any and/or all of the factors data and/or information, the factor ratios data and/or information, data and/or information regarding stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or data and/or information regarding factors which serve as factors, and/or the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration.

At step 405, the central processing computer 10 will perform all necessary searches and calculations needed in order to provide the requested factor and/or factor model information, and to provide the requested stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), information including any historical correlational information regarding the respective stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and any of the factors, factor ratios, stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, commodities which serve as factors, and/or factors which serve as factors, and/or the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration.

At step 405, the central processing computer 10 will also perform any requested statistical and/or forecasting calculations and/or analyses in order to provide forecasts for the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), as these forecasts may relate to the factor and/or factor ratio information and/or as the forecast may relate to any other information. The central processing computer 10 will thereafter, at step 406, generate a report in response to the individual's request at step 403.

The report can contain a list of factors and/or factor models, which were either specifically requested and/or identified, and/or which were identified as being responsive to the request and/or which were identified as having been recently changed and/or updated and/or modified. The report can also contain information regarding the state(s), value(s), changes in value(s), and/or percent changes in value(s), of the factors, factor ratios, stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and factors which serve as factors, and/or information regarding any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which were either requested and/or identified as a result of the request at step 403 and/or identified as a result of the processing at step 405.

The report can also contain historical data and/or information concerning any correlation between the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and any factor(s), factor ratio(s), and/or stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), contained therein, as well as past behavior of the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The report can also contain statistical predictions and/or forecasts regarding future behavior, price movements, and/or valuation, of the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), contained in the report.

The report may also contain information regarding a news event, a news report, or a news story, or the plural of same, which may or may not have been requested by the individual. The report may also contain information regarding an advertisement or advertisements regarding a good, a product, or a service, or the plural of same.

At step 407, the central processing computer 10 will transmit a notification signal or message to the individual computer 10 in order to notify the individual of the detected occurrence of, state of, change in state of, change in value of, and/or percent change in value of, the factor(s), factor ratio(s), stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or a factor or factors which serve as factors, which was requested by the individual at step 403.

The notification signal or message may also contain information regarding a news event, a news report, or a news story, or the plural of same, which may or may not have been requested by the individual. The notification signal or message may also contain information regarding an advertisement or advertisements regarding a good, a product, or a service, or the plural of same.

The central processing computer 10 will also, at step 407, transmit the report, generated at step 406, to the individual computer 20. At step 408, the report can be viewed by the individual via the display device 20E and/or be output from the output device 201, such as by being printed from a printer. While described as being transmitted to the individual computer 20 and being viewed and/or output via the respective display device 20E and/or output device 201, the report may, in addition and/or in the alternative, be transmitted to the individual via electronic transmission, e-mail transmission, facsimile transmission, telephone message, telephone call, physical mail delivery, and/or via any other suitable communication technique, medium, or method. Thereafter, the operation of the apparatus 100 will cease at step 409.

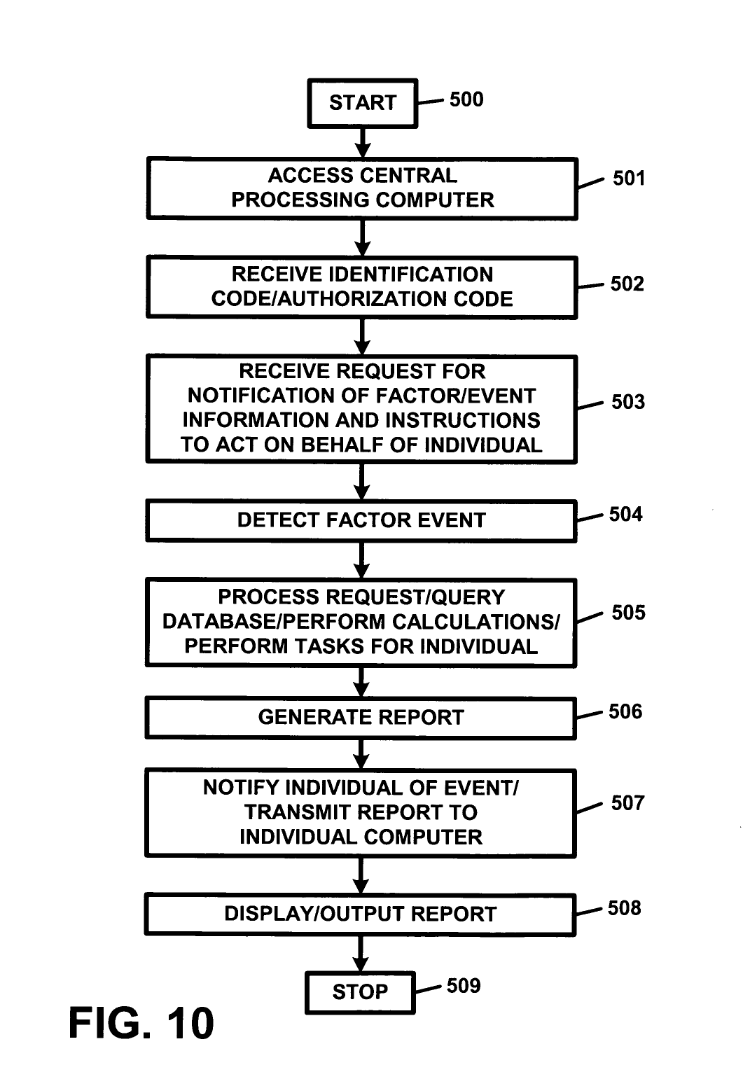

FIG. 10 illustrates another preferred embodiment of the present invention in which the apparatus 100 can be utilized in order to provide security, protection, and/or investment protection and/or portfolio protection, for the individual's financial account, brokerage account, investment account, investment portfolio, commodities account, and/or consumer account. This can be accomplished by ascertaining a change in a factor(s), factor ratio(s), stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, determine the affect which the change in a factor(s), factor ratio(s), stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, may have on the financial account, brokerage account, commodity trading account, investment account, investment portfolio, and/or consumer account, and taking pre-authorized actions on behalf of the individual in order to perform transactions and/or trades on the individual's account, and/or otherwise, in order to protect the respective account and/or the value of the account.

The apparatus 100 can also act on behalf of the individual in order to, purchase, buy, sell, trade, exchange, borrow, take or obtain a position in, liquidate a position in, and/or perform and/or engage in any other activity relating to or regarding, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), described herein, in response to a change in a factor, a factor ratio, a stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serves as a factor, and/or a factor which serves as a factor.

The operation of the apparatus commences at step 500. At step 501, the individual can access the central processing computer 10 via the individual computer 20 associated with the individual. In any and/or all of the embodiments described herein, the individual computer 20 can also take the form of a kiosk or terminal which is located at a pubic place or location. At step 502, the individual can enter a personal identifier and/or authorization code, if required for security purposes, which is received by the central processing 10.

At step 503, the individual can enter a request to be notified upon the occurrence of an event, a state of, a change in state of, a change in value of, and/or a percent change in value of, and/or for, any of the factors, factor ratios, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), any factors which serve as factors, a single factor, and/or a single factor ratio, described herein.

The individual can also, at step 503, request to receive any of the information described herein as being provided by the present invention, such as, for example, how the respective occurrence, state, change in state, change in value, and/or percent change in value, can or may effect any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), of interest to the individual. This request will also be received by the central processing computer 10 at step 503.

At step 503, the individual may also request to receive information regarding any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which may have a correlation of any kind, positive, negative, or no correlation, with any of the factors, factor ratios, stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or factors which serve as factors, which have been requested and/or which may be identified as a result of any search and/or query performed pursuant to the request made at step 503.

At step 503, historical data and/or information and/or statistical information and/or forecasting information regarding any of the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration may also be requested.

At step 503, the individual can also instruct and/or authorize the central processing computer 10 to take action, on behalf of the individual, in order to protect his or her financial account, brokerage account, commodity trading account, investment account, investment portfolio, and/or consumer account. For example, if a change in a factor, a factor ratio, a stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serves as a factor, may have a detrimental effect on the individual's financial account, brokerage account, commodity trading account, investment account, investment portfolio, and/or consumer account, the individual can instruct and/or authorize the central processing computer 10 to perform a transaction or transactions, such as, but not limited to, purchasing, buying, selling, trading, exchanging, borrowing, obtaining or taking a position in, liquidating a position in, and/or performing and/or engaging in any other activity relating to or regarding, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), described herein, which may be expected to lose its value, and/or close any open positions in any security, derivative and/or other instrument, expected to have a detrimental effect on the individual's account or investment portfolio.

The central processing computer 10 can also perform any type of transaction, investment transaction, and/or investment-related transaction and/or activity, and/or any analysis and/or processing related to same, which can otherwise be performed by an individual, an investor, and/or any respective individual, party, and/or entity, regarding any of the accounts described herein. The central processing computer 10 can also perform any type of transaction, investment transaction, and/or investment-related transaction and/or activity, which can be otherwise performed by any account, portfolio, investment portfolio, and/or other suitable entity.

Any instructions and/or authorizations provided by the individual, at step 503 and/or at any other time, can be legally binding on the individual and may be accompanied by an electronic signature and/or by an electronic form submission and/or a written submission of a power of attorney and/or authorization to perform transactions on behalf of the individual.

At step 503, the individual can also enter a request to receive information regarding a news event, a news report, or a news story, or the plural of same. At step 503, the individual can also enter a request to receive information regarding an advertisement or advertisements regarding a good, a product, or a service, or the plural of same.

At step 504, the central processing computer 10 detects the occurrence of, the state of, the change in state of, the change in value of, and/or the percent change in value of, the factor(s), factor ratio(s), stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or a factor or factors which serve as factors, which were specified by the individual at step 503.

At step 505, the central processing computer 10 will process the request made at step 503 and perform a search and/or database query of the database 10H in conjunction with any and/or all of the factors data and/or information, the factor ratios data and/or information, data and/or information regarding stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or data and/or information regarding factors which serve as factors, and/or the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and/or factors under consideration.

At step 505, the central processing computer 10 will perform all necessary searches and calculations needed in order to provide the requested factor and/or factor model information, and to provide the requested information regarding the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), information, including any historical correlational information regarding the respective stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and/or any of the factors, factor ratios stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, commodities which serve as factors, and/or factors which serve as factors, and/or the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), under consideration.

At step 505, the central processing computer 10 will also, perform any requested statistical and/or forecasting calculations and/or analyses in order to provide forecasts for the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), as these forecasts may relate to the factor and/or factor ratio information and/or as the forecast may relate to any other information.

At step 505, the central processing computer 10 will also, if appropriate and/or necessary, take any action or actions, on behalf of the individual pursuant to the instructions and/or authorizations provided by the individual, at step 503. For example, if a change in a factor, a factor ratio, and/or a stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serves as a factor, may have a detrimental effect on the individual's investment portfolio, or the price of the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), the central processing computer 10, pursuant to the individual's instructions and/or authorization, may perform a necessary transaction or transactions, such as, but not limited to, purchasing, buying, selling, trading, borrowing, exchanging, taking or obtaining a position in, and/or liquidating a position in, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which may be expected to lose its value, and/or close any open positions in any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), expected to have a detrimental effect on the individual's account or investment account or portfolio.

The central processing computer 10 will thereafter, at step 506, generate a report in response to the individual's request at step 503.

The report can contain a list of factors and/or factor models, which were either specifically requested and/or identified, and/or which were identified as being responsive to the request and/or which were identified as having been recently changed and/or updated and/or modified. The report can also contain information regarding the state(s), value(s), changes in value(s), and/or percent changes in value(s), of the factors, factor ratios, stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and factors which serve as factors, and/or information regarding any stock(s), bond(s), security or securities, portfolio(s) of securities, market instrument(s), index instrument(s), mutual find(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which were either requested and/or identified as a result of the request at step 503 and/or identified as a result of the processing at step 505.

The report can also contain historical data and/or information concerning any correlation between the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and any factor(s), factor ratio(s), stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), contained therein, as well as past behavior of the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The report can also contain statistical predictions and/or forecasts regarding future behavior, price movements, and/or valuation, of the stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), contained in the report.

The report can also include a description of any actions taken by the central processing computer 10, on behalf of the individual. For example, the report may notify the individual that the central processing computer 10 has purchased, bought, sold, traded, borrowed, exchanged, obtained a position in, and/or liquidated a position in, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), for, or on behalf of, the individual and/or in the individual's account, and/or performed any other operation pursuant to the individual's instructions at step 503.

The report may also contain information regarding a news event, a news report, or a news story, or the plural of same, which may or may not have been requested by the individual. The report may also contain information regarding an advertisement or advertisements regarding a good, a product, or a service, or the plural of same.

At step 507, the central processing computer 10 will transmit a notification signal or message, including the report, to the individual computer 10 in order to notify the individual of the detected occurrence of, state of, change in state of, change in value of, and/or percent change in value of, the factor(s), factor ratio(s), stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), which serve as factors, and/or a factor or factors which serve as factors, which were requested by the individual at step 503.

The notification signal or message will also include the action taken by the central processing computer 10. For example, if the central processing computer acted on behalf of the individual in order to purchase, buy, sell, trade, borrow, exchange, take or obtain a position in, and/or liquidate a position in, any stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), for, or on behalf of, the individual and/or in the individual's account, and/or perform any other operation or transaction pursuant to the individual's instructions at step 503, the notification signal or message or the report will include information regarding these actions taken by the central processing computer.

The notification signal or message may also contain information regarding a news event, a news report, or a news story, or the plural of same, which may or may not have been requested by the individual. The notification signal or message may also contain information regarding an advertisement or advertisements regarding a good, a product, or a service, or the plural of same.

The central processing computer 10 will also, at step 507, transmit the report, generated at step 506, to the individual computer 20. At step 508, the report can be viewed by the individual via the display device 20E and/or be output from the output device 20I, such as by being printed from a printer. While described as being transmitted to the individual computer 20 and being viewed and/or output via the respective display device 20E and/or output device 20I, the report may, in addition and/or in the alternative, be transmitted to the individual via electronic transmission, e-mail transmission, facsimile transmission, telephone message, telephone call, physical mail delivery, and/or via any other suitable communication technique, medium, or method.

Thereafter, the operation of the apparatus 100 will cease at step 509.

In any and/or all of the embodiments described herein, any and/or all calculations, statistical calculations, regression analysis, forecasting calculations, etc., can be performed by the central processing computer 10 by utilizing methods and techniques known by those skilled in the financial calculation, analysis and/or forecasting, arts and/or by statisticians trained in financial analysis.

The present invention provides an apparatus and a method for use thereof which can process a request for information regarding a financial factor, a factor, a factor model, and/or a factor ratio. The apparatus can process the request for information in conjunction with data and/or information which is stored internal to the apparatus and/or any of its computers and/or processing devices and/or which is stored external from the apparatus and/or any of its computers and/or processing devices.

The apparatus can generate a report responsive to the request. The report can contain information regarding a financial factor, a factor, a factor model, a factor ratio, and/or a stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The report can also contain data and/or information regarding historical, statistical, and forecasting, information regarding the financial factor, factor, factor model, factor ratio, and/or any stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The apparatus and method of the present invention can also process a request for information concerning a stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The apparatus can process the request in conjunction with data and/or information which is stored internal to the apparatus and/or any of its computers and/or processing devices and/or which can be stored external from the apparatus and/or any of its computers and/or processing devices. The apparatus can generate a report which contains data and/or information regarding historical, statistical, and/or forecasting, information regarding a financial factor, a factor, a factor model, a factor ratio, and/or a stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The apparatus and method of the present invention can also process a request to provide notification to an individual regarding information regarding a financial factor, a factor, a factor model, a factor ratio, and/or a stock(s), bond(s), security or securities, portfolio(s) of securities, market instrument(s), index instrument(s), financial market(s), market index or indices, mutual fund(s), trust(s), real estate investment trust(s), real estate, real property or real properties, currency or currencies, commodity or commodities, foreign exchange rate(s), interest rate(s), utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and generate a report responsive to the request. The apparatus can process the request in conjunction with data and/or information which is stored internal to the apparatus and/or any of its computers and/or processing devices and/or which can be stored external from the apparatus and/or any of its computers and/or processing devices.

The report can contain information for providing the requested notification and/or information regarding the financial factor, factor, factor model, factor ratio, and/or stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The report can also contain historical, statistical, and/or forecasting, information regarding the financial factor, factor, factor model, factor ratio, and/or stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The apparatus and method of the present invention can also process a request for providing protection for or regarding any of the accounts and/or portfolios described herein. The apparatus can process a request for providing account and/or portfolio protection. The apparatus can process the request in conjunction with data and/or information which is stored internal to the apparatus and/or any of its computers and/or processing devices and/or which can be stored external from the apparatus and/or any of its computers and/or processing devices.

The apparatus can perform a transaction on the account or portfolio pursuant to the request for protection. The apparatus can also generate a report responsive to the request. The report can contain information regarding a financial factor, a factor, a factor model, and/or a factor ratio, and a financial factor, a factor, a factor model, a factor ratio, and/or a stock(s), bond(s), security or securities, portfolio(s) of securities, market instrument(s), index instrument(s), financial market(s), market index or indices, mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and/or information regarding the transaction which is performed.

The apparatus of the present invention can receive requests from any of the respective individuals and/or entities, and/or from any of the computers and/or communication devices associated therewith, via any of the herein-described and/or other suitable communication networks or systems. The apparatus of the present invention can transmit any of the herein-described reports, responses, and/or information, to any of the herein-described individuals and/or entities, and/or to the computers and/or communication devices associated therewith, via any of the herein-described and/or other suitable communication networks or systems.

In any and/or all of the embodiments described herein, any of the data and/or information provided by the apparatus, the central processing computer, and/or any of the other computers and/or communication devices described herein, can be provided at text information, graphical information, video information, audio information, and/or in any combination of the above. The apparatus 100 and/or the central processing computer 10 can also provide instructional information and/or educational information regarding any of the herein described factors, financial factors, factor models, factor ratios, stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), and/or any information, correlational, historical, statistical, and/or otherwise which may be provided by the present invention. In this manner, for example, any of the information, notification information, and/or any reports, described herein, can include, and/or be can accompanied by, any text information, graphical information, video information, such as video clips, audio information, such as audio clips, and/or any combination of same.

The present invention provides an apparatus which can receive requests from individuals to be notified upon the occurrence of a change in any of the factors, financial factors, factor models, factor ratios, stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s), as well as provide information to the individual regarding what impact, if any, the detected change may have regarding any of the herein-described stock(s), bond(s), security or securities, portfolio(s) of securities, market instrument(s), index instrument(s), mutual fund(s), trust(s), currency or currencies, commodity or commodities, foreign exchange rate(s), interest rate(s), real estate investment trust(s), real estate, real property or real properties, utility service(s) and/or utility product(s), energy service(s) and/or energy product(s), telecommunication service(s) and/or telecommunication product(s), debt product(s), credit product(s), credit derivative product(s), derivative(s), option(s), future(s), forward(s), and/or other contract(s) associated therewith and/or related thereto, and/or any other financial instrument(s) and/or other instrument(s).

The apparatus of the present invention can also receive instructions from an individual and perform transactions for, or on behalf of, the individual, in response to a detected change in any of the herein-described factors, financial factors, factor models, factor ratios, stocks, bonds, security or securities, portfolios of securities, market instruments, index instruments, mutual funds, trusts, currency or currencies, commodity or commodities, foreign exchange rates, interest rates, real estate investment trust(s), utility services and/or utility products, energy services and/or energy products, telecommunication services and/or telecommunication products, debt products, credit products, credit derivative products, derivatives, options, futures, forwards, and/or other contracts associated therewith and/or related thereto, and/or any other financial instruments and/or other instruments.

The present invention can also be utilized to provide information, or a notification or alert, of or regarding a news event, a news report, or a news story, or the plural of same. The present invention can also be utilized to provide an advertisement or advertisements regarding a good, a product, or a service, or the plural of same.

The present invention, in any and/or all of the embodiments described herein, can be utilized to provide subscription-based services and/or non-subscription-based services.

The central processing computer 10 may be an integral component and/or system of a financial computer system, an on-line financial computer system, a brokerage computer system, a commodities trading computer system, an on-line brokerage computer system, a utility product(s) and/or service(s) trading computer system, an energy product(s) and/or service(s) trading computer system, a communication product(s) and/or service(s) trading computer system, and/or a telecommunication product(s) and/or service(s) trading computer system. In this manner, the central processing computer 10 of the present invention can be an integral component of any computer servicing financial accounts, on-line financial accounts, brokerage accounts, commodities trading accounts, on-line brokerage accounts, utility trading accounts, energy trading accounts, communication trading accounts, telecommunication trading accounts.

In the preferred embodiment, wherein the apparatus 100 is utilized over the Internet and/or the World Wide Web, hyperlinks and/or other data and/or information links and/or linking methods and/or devices, can be utilized in order to provide an additional mechanism by which any of the respective computers 10, 20, 30, 40, and/or 50, and/or any of their respective databases 10H, 20H, 30H, 40H, and/or 50H, can access and/or communicate with any other individual other of the computers and/or databases described herein.

The data and/or information which is stored in the database 10H, 20H, 30H, 40H, and/or 50H, can be linked via any suitable data linking techniques such as, for example, dynamically linked lists (DLLs), linked lists, and object links embedded (OLE's).

In any and all of the embodiments described herein, each of the respective computer 10, 20, 30, 40 and/or 50, can communicate with one another via electronic submissions, electronic form submissions and/or transmissions, e-mail transmissions, facsimile transmissions, telephone messages, telephone calls, physical mail delivery, and/or via any other suitable communication technique, medium, or method.

In another preferred embodiment, as well as in any of the embodiments described herein, intelligent agents, software agents, mobile agents, and/or related technologies, can be utilized in conjunction with the present invention.

The respective intelligent agent(s), software agent(s), mobile agent(s), (hereinafter referred to collectively as “intelligent agent” or “intelligent agents”) can be programmed and/or designed to act on behalf of the respective individual, financial institution or financial intermediary, external information source, and/or security issuer or trader, commodity seller or trader, and/or any issuer, seller, buyer, and/or trader of any of the herein described securities, bonds, instruments, commodities, products, services, and/or derivatives and/or contracts, described herein, so as to perform any of the searches, information updates, calculations, forecasting, and/or any other operations described herein.

The intelligent agent can act on behalf of the respective party in various related interactions and/or other activities which are described as being performed herein and/or which may be incidental and/or related thereto. Therefore, the present invention also provides an agent-based apparatus and method for providing financial information and/or investment information.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, and/or any of the communications, which are described herein, between any of the parties which utilize the present invention.

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, digital television networks or systems, cellular communication networks or systems, broadband communication networks or systems, bluetooth communication networks or systems, low earth orbiting satellite (LEOs) networks or systems, as well as in, or on any internets and/or intranets, the Internet, the World Wide Web, and/or any other suitable communication network or system, and/or any combination of same.

The data and/or information, described as being stored in the database 10H and/or in any of the other databases described herein, can be continuously updated so as to store the latest values for the data and/or information and can be stored and be made available for future calculations, analyses and/or processing.

Any and/or all of the data and/or information described herein, which is stored in the database 10H, or in the collection of databases, can be linked via relational database techniques and/or via any appropriate database management techniques. The data and/or information, in the preferred embodiments, can be updated via inputs from any of the computers 10, 20, 30, 40, and/or 50, described herein, in real-time, and/or via dynamically linked database management techniques. The above-described updates can also be provided from other information sources via the communication network.

The data and/or information which is stored in the database 10H and/or which may be otherwise utilized with, and/or in conjunction with, the apparatus and method of the present invention, can be linked via any suitable data linking techniques such as, for example, dynamically linked lists (DLLs), linked lists, and object links embedded (OLE's). Any suitable database management technique(s) may also be utilized in conjunction with the present invention.

Applicant hereby incorporates by reference herein the subject matter of U.S. Pat. No. 5,903,830 which teaches a transaction security apparatus and method; U.S. Pat. No. 5,878,337 which teaches a transaction security apparatus and method; U.S. Pat. No. 5,940,809 which teaches a securities, portfolios of securities, mutual funds, trusts, brokerage-asset management system; U.S. Pat. No. 5,270,922 which teaches a system for distributing, processing and displaying financial information; U.S. Pat. No. 4,774,663 which teaches a securities, portfolios of securities, mutual funds, trusts, brokerage-cash management system with short term investment proceeds allotted among multiple accounts; U.S. Pat. No. 4,674,044 which teaches an automated securities, portfolios of securities, mutual funds, trusts, trading system; U.S. Pat. No. 5,920,848 which teaches a method and system for using intelligent agents for financial transactions, services, accounting, and advise; U.S. Pat. No. 5,890,140 which teaches a system for communicating with an electronic delivery system that integrates global financial services; U.S. Pat. No. 5,710,889 which teaches an interface device for electronically integrating global financial services; U.S. Pat. No. 5,703,949 which teaches a method for establishing secure communications among processing devices; U.S. Pat. No. 5,671,280 which teaches a system and method for commercial payments using trusted agents; U.S. Pat. No. 5,245,535 which teaches a system for demonstrating financial concepts and displaying financial data; U.S. Pat. No. 4,751,640 which teaches an automated investment system; and U.S. Pat. No. 5,193,056 which teaches a data processing system for hub and spoke financial services configuration.

Applicant also incorporates by reference herein the teachings of Modern Investment Theory, Fourth Edition, Robert A. Haugen, Prentice Hall 1997; Options, Futures, And Other Derivatives, Third Edition, John C. Hull, Prentice Hall 1997; Futures, Options & Swaps, Second Edition, Robert W. Kolb, Blackwell Business, 1997; Bond Markets, Analysis And Strategies, Third Edition, Frank J. Fabozzi, Prentice Hall, 1996; Capital Markets And Institutions: A Global View, Linda Allen, Wiley 1997; Financial Institutions Management: A Modern Perspective, Second Edition, Anthony Saunders, McGraw Hill 1997; Multinational Business Finance, Eighth Edition, David K. Eiteman, et al., Addison Wesley, 1998; The Handbook Of Credit Derivatives, Jack Clark Francis, et al., McGraw Hill, 1999; Credit Derivatives: Trading & Management Of Credit & Default Risk, Satyajit Das, Wiley 1998.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for providing financial information or investment information, comprising:
a receiver, wherein the receiver receives a request to provide a notification of a change in at least one factor and information regarding a correlation of the at least one factor with at least one of a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account;
a processor, wherein the processor automatically detects a change in at least one factor upon an occurrence of a change in the at least one factor, and further wherein the processor processes the request and generates a message containing information regarding the change in the at least one factor along with information regarding a correlation of the at least one factor with at least one of a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account; and
a transmitter for transmitting the message over a communication network to a communication device associated with an individual,
wherein the apparatus automatically initiates a communication link with the communication device, and further wherein the transmitter transmits the message over the communication network to the communication device, and further wherein the message is transmitted to the communication device in real-time.

2. The apparatus of claim 1, wherein the at least one factor is at least one of a financial factor, a factor model, a factor ratio, a stock, a bond, a security, a portfolio of securities, a financial market, a market index, a currency, a commodity, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, a technical factor, a fundamental factor, an economic factor, a market factor, a utility factor, a commodity factor, an energy factor, a psychological factor, an environmental factor, a time factor, a timing factor, and a news event, and further wherein the message further contains at least one of statistical information, forecasting information, and historical information, a forecast regarding a future behavior, a forecast regarding a price movement, and a forecast regarding a valuation, regarding the at least one of a stock, a bond, a security, securities, a portfolio of securities, a market instrument, an index instrument, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a debt product, a credit product, a credit derivative product, a derivative, an option, a future, a forward, a contract, and a financial instrument.

3. The apparatus of claim 1, wherein the communication device is at least one of a personal computer, a network computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and a watch, and further wherein the message contains at least one of a text information, graphical information, a chart, a table, video information, an image, and audio information, and further wherein the message is transmitted to the communication device via, on, or over, at least one of the Internet, the World Wide Web, a wireless communication network, a cellular communication network, a digital television network, and a cable television network.

4. The apparatus of claim 1, wherein the information stored in the database is automatically updated in real-time by at least one of a financial institution computer, a financial intermediary computer, an external information source computer, and a security issuer computer.

5. The apparatus of claim 1, wherein the message contains an advertisement.

6. The apparatus of claim 1, further comprising:
a database, wherein the database stores information regarding the at least one factor and the information regarding at least one of a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account, which is correlated with the at least one factor, wherein the at least one factor is at least one of a financial factor, a factor model, a factor ratio, a financial factor, a technical factor, a fundamental factor, an economic factor, a market factor, a utility factor, a commodity factor, an energy factor, a psychological factor, an environmental factor, a time factor, a timing factor, a news event, a stock, a bond, a security, a portfolio of securities, a financial market, a market index, a currency, a commodity, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, and a contract;
wherein the processor automatically detects a change in the at least one factor upon an occurrence of a change in the at least one factor, and further wherein the processor processes the request using information stored in the database, wherein the processor generates the message containing information regarding the change in the at least one factor and information regarding at least one of a stock, a bond, a security, securities, a portfolio of securities, a market instrument, an index instrument, a financial market, a market index, a mutual find, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account, which is correlated with the at least one factor, wherein the message further contains at least one of historical information, statistical information, and forecasting information, and further wherein the message contains at least one of a text information, graphical information, a chart, a table, video information, an image, and audio information, and further wherein the communication device is at least one of a personal computer, a network computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and a watch, and further wherein the message is transmitted to the communication device via, on, or over, at least one of the Internet, the World Wide Web, a wireless communication network, a cellular communication network, a digital television network, and a cable television network.

7. The apparatus of claim 6, wherein the information stored in the database is automatically updated in real-time by at least one of a financial institution computer, a financial intermediary computer, an external information source computer, and a security issuer computer.

8. The apparatus of claim 6, wherein the message further contains at least one of a forecast regarding a future behavior, a forecast regarding a price movement, and a forecast regarding valuation, regarding the at least one of a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account.

9. The apparatus of claim 6, wherein the message contains an advertisement.

10. An apparatus for providing financial information or investment information, comprising:
a receiver, wherein the receiver receives a request to provide a notification of a change in at least one factor and information regarding a correlation of a change in at least one factor with at least one of a financial account, a brokerage account, a trading account, a commodity trading account, an investment account, an investor portfolio account, a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account;
a processor, wherein the processor automatically detects a change in at least one factor upon an occurrence of a change in the at least one factor, and further wherein the processor determines a correlation of the change in at least one factor with at least one of a financial account, a brokerage account, a trading account, a commodity trading account, an investment account, an investor portfolio account, a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account, and further wherein the processor generates a message containing information regarding at least one of the change in at least one factor and the correlation of the change in at least one factor with the at least one of a financial account, a brokerage account, a trading account, a commodity trading account, an investment account, an investor portfolio account, a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account; and
a transmitter for transmitting the message over a communication network to a communication device associated with an individual,
wherein the apparatus automatically initiates a communication with the communication device, and further wherein the transmitter transmits the message over the communication network to the communication device, and further wherein the message is transmitted to the communication device in real-time, and further wherein the message is transmitted to the communication device via, on, or over, at least one of the Internet, the World Wide Web, a wireless communication network, a cellular communication network, a digital television network, and a cable television network.

11. The apparatus of claim 10, wherein the at least one factor is at least one of a financial factor, a factor model, a factor ratio, a stock, a bond, a security, a portfolio of securities, a financial market, a market index, a currency, a commodity, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, a technical factor, a fundamental factor, an economic factor, a market factor, a utility factor, a commodity factor, an energy factor, a psychological factor, an environmental factor, a time factor, a timing factor, and a news event.

12. The apparatus of claim 10, wherein the communication device is at least one of a personal computer, a network computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and a watch, and further wherein the message contains at least one of a text information, graphical information, a chart, a table, video information, an image, and audio information.

13. The apparatus of claim 10, further comprising:
a database, wherein the database stores information regarding the at least one factor and information regarding the at least one of a financial account, a brokerage account, a trading account, a commodity trading account, an investment account, an investor portfolio account, a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account, which is correlated with the at least one factor.

14. The apparatus of claim 10, wherein the information stored in the database is automatically updated in real-time by at least one of a financial institution computer, a financial intermediary computer, an external information source computer, and a security issuer computer.

15. The apparatus of claim 10, wherein the message contains an advertisement.

16. The apparatus of claim 10, wherein the message contains information regarding at least one of a patent grant and an insider trading activity.

17. An apparatus for providing financial information or investment information, comprising:
a receiver, wherein the receiver receives a request to provide a notification of a change in at least one factor along with information regarding a correlation of the change in at least one factor with at least one of a financial account, a brokerage account, a trading account, a commodity trading account, an investment account, an investor portfolio account, a stock, a bond, a security, securities, a portfolio of securities, a market instrument, an index instrument, a financial market, a market index, a mutual find, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account, and an instruction to perform a transaction on behalf of an individual;
a processor, wherein the processor automatically detects a change in at least one factor upon an occurrence of a change in the at least one factor, and further wherein the processor determines a correlation of the change in at least one factor with at least one of a financial account, a brokerage account, a trading account, a commodity trading account, an investment account, an investor portfolio account, a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account, and further wherein the processor automatically performs a transaction on the at least one of a financial account, a brokerage account, a trading account, a commodity trading account, an investment account, and an investor portfolio account, on behalf of the individual pursuant to the instruction,
wherein the processor generates a message containing information regarding at least one of the change in at least one factor, the correlation of the change in at least one factor with at least one of a financial account, a brokerage account, a trading account, a commodity trading account, an investment account, an investor portfolio account, a stock, a bond, a security, securities, a portfolio of securities, a market instrument, an index instrument, a financial market, a market index, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, a contract, and an account, and information regarding the transaction performed on the at least one of a financial account, a brokerage account, a trading account, a commodity trading account, an investment account, and an investor portfolio account, on behalf of the individual; and
a transmitter for transmitting the message over a communication network to a communication device associated with the individual,
wherein the apparatus automatically initiates a communication link with the communication device, and further wherein the transmitter transmits the message over the communication network to the communication device, and further wherein the message is transmitted to the communication device in real-time.

18. The apparatus of claim 17, wherein the communication device is at least one of a personal computer, a network computer, a hand-held computer, a palmtop computer, a laptop computer, a personal communication device, a personal digital assistant, a telephone, a digital telephone, a display telephone, a video telephone, a videophone, a 3G telephone, a 3.5 G telephone, a 4G telephone, a cellular telephone, a wireless telephone, a television, an interactive television, a beeper, a pager, and a watch, and further wherein the message contains at least one of a text information, graphical information, a chart, a table, video information, an image, and audio information, wherein the message contains and advertisement, and further wherein the message is transmitted to the communication device via, on, or over, at least one of the Internet, the World Wide Web, a wireless communication network, a cellular communication network, a digital television network, and a cable television network.

19. The apparatus of claim 17, wherein the instruction includes at least one of a legally binding authorization, an electronic signature, an electronic form submission of a power of attorney, and a written submission of a power of attorney, to perform a transaction on behalf of the individual.

20. The apparatus of claim 17, wherein the transaction involves at least one of purchasing, buying, selling, trading, borrowing, exchanging, taking a position in, obtaining a position in, and liquidating a position in, at least one of a stock, a bond, a security, securities, a portfolio of securities, a market instrument, an index instrument, a mutual fund, a trust, a currency, currencies, a commodity, commodities, a foreign exchange rate, an interest rate, a utility service, a utility product, an energy service, an energy product, a telecommunication service, a telecommunication product, a bandwidth service, a bandwidth product, a debt product, a credit product, a credit derivative product, a derivative, an option, a future, a forward, a financial instrument, and a contract associated with at least one of a stock, a bond, a security, securities, a portfolio of securities, a market instrument, an index instrument, a mutual fund, a trust, a currency, currencies, a commodity, commodities, a foreign exchange rate, an interest rate, a real estate investment trust, real estate, real property or real properties, a utility service, a utility product, an energy service, an energy product, a telecommunication service, a telecommunication product, a bandwidth service, a bandwidth product, a debt product, a credit product, a credit derivative product, a derivative, an option, a future, a forward, and a financial instrument.
